(19) United States
(12) Patent Application Publication
(10) Pub. No.: US 2016/0227227 A1
(43) Pub. Date: Aug. 4, 2016

(54) COLOR INFORMATION AND CHROMATICITY SIGNALING

(71) Applicant: Sharp Kabushiki Kaisha, Osaka-shi, Osaka (JP)

(72) Inventor: Sachin G. DESHPANDE, Camas, WA (US)

(73) Assignee: Sharp Kabushiki Kaisha, Osaka-shi, Osaka (JP)

(21) Appl. No.: 15/026,696

(22) PCT Filed: Oct. 9, 2014
(86) PCT No.: PCT/JP2014/005155

§ 371 Date: Apr. 1, 2016

Related U.S. Application Data
(60) Provisional application No. 61/889,883, filed on Oct. 11, 2013.

(51) Int. Cl. H04N 19/186; H04N 19/157; H04N 19/187; H04N 19/593; H04N 19/517; H04N 19/30; H04N 19/107; H04N 19/70

(52) U.S. Cl. CPC H04N 19/186; H04N 19/107; H04N 19/157; H04N 19/70; H04N 19/593; H04N 19/517; H04N 19/30; H04N 19/187

(57) ABSTRACT

This invention relates to a method for decoding video comprising: (a) receiving a video bitstream of encoded pictures, wherein said video bitstream includes a plurality of layers; and (b) receiving chromaticity information related to said video bitstream, wherein said chromaticity information includes (1) one or more sets of information on said video signal; (2) the number of said set of said information on said video signal; (3) an index of said information on said video signal; and (4) a flag which indicates whether or not said number and said index are present.

### TECHNICAL FIELD

This disclosure relates generally to video coding, and, more particularly, to color information and chromaticity signaling for video coding.

### BACKGROUND ART

Many systems include a video encoder to implement video coding standards and compress video data for transmission over a channel with limited bandwidth and/or limited storage capacity. These video coding standards can include multiple coding stages such as intra prediction, transform from spatial domain to frequency domain, inverse transform from frequency domain to spatial domain, quantization, entropy coding, motion estimation, and motion compensation, in order to more effectively encode frames.

### SUMMARY OF INVENTION

### Technical Problem

Traditional digital High Definition (HD) content can be represented in a format described by video coding standard International Telecommunication Union Radio-communication Sector (ITU-R) Recommendation BT.709, which defines a resolution, a color gamut, a gamma, and a quantization bit-depth for video content. With an emergence of higher resolution video standards, such as ITU-R Ultra High Definition Television (UHDTV), which, in addition to having a higher resolution, can have wider color gamut and increased quantization bit-depth compared to BT.709, many legacy systems based on lower resolution HD content may be unable to utilize compressed UHDTV content. One of the current solutions to maintain the usability of these legacy systems includes separately simulcasting both compressed HD content and compressed UHDTV content. Although a legacy system receiving the simulcasts has the ability to decode and utilize the compressed HD content, compressing and simulcasting multiple bitstreams with the same underlying content can be an inefficient use of processing, bandwidth, and storage resources.

### Solution to Problem

According to the present invention, there is a provided a method for decoding video comprising: (a) receiving a video bitstream of encoded pictures, wherein said video bitstream includes a plurality of layers; and (b) receiving chromaticity information related to said video bitstream, wherein said chromaticity information includes (1) a set of a video signal information; (2) the number of said set of said video signal information; (3) an index of said video signal information; and (4) a flag which indicates whether or not said number and said index are present.

The foregoing and other objectives, features, and advantages of the invention will be more readily understood upon consideration of the following detailed description of the invention, taken in conjunction with the accompanying drawings.

### BRIEF DESCRIPTION OF DRAWINGS

FIG. 1 is a block diagram example of a video coding system.

FIG. 2 is an example graph 200 illustrating color gamuts supported in a BT.709 video standard and in a UHDTV video standard.

FIG. 3A is block diagram example of the video encoder shown in FIG. 1.

FIG. 3B is block diagram example of the video encoder shown in FIG. 1.

FIG. 4 is a block diagram example of the color space predictor shown in FIGS. 3A and 3B.

FIG. 5A is block diagram example of the video decoder shown in FIG. 1.

FIG. 5B is block diagram example of the video decoder shown in FIG. 1.

FIG. 6 is a block diagram example of a color space predictor shown in FIGS. 5A and 5B.

FIG. 7 is an example operational flowchart for color space prediction in the video encoder shown in FIG. 1.

FIG. 8 is an example operational flowchart for color space prediction in the video decoder shown in FIG. 1.

FIG. 9 is another example operational flowchart for color space prediction in the video decoder shown in FIG. 1.

FIG. 10A is block diagram example of video encoders that include color bit depth scaling.

FIG. 10B is block diagram example of video encoders that include color bit depth scaling.

FIG. 11 is a flow diagram of an encoding method that includes bit depth scaling.

FIG. 12A is block diagram example of the video decoders that include color bit depth scaling.

FIG. 12B is block diagram example of the video decoders that include color bit depth scaling.

FIG. 13 is a flow diagram of an decoding method that includes bit depth scaling.

FIG. 14A illustrates an exemplary vps_extension( ) syntax.

FIG. 14B illustrates an exemplary vps_extension( ) syntax.

FIG. 15 illustrates an exemplary vps_vui( ) syntax.

FIG. 16A illustrates an exemplary seq_parameter_set_rbsp( ) syntax.

FIG. 16B illustrates an exemplary seq_parameter_set_rbsp( ) syntax.

FIG. 16C illustrates an exemplary seq_parameter_set_rbsp( ) syntax.

FIG. 17 illustrates an exemplary vui_parameters( ) syntax.

FIG. 18 illustrates an exemplary video_signal_info( ) syntax.

FIG. 19 illustrates an exemplary video_signal_info( ) syntax.

FIG. 20 illustrates an exemplary video_signal_info( ) syntax.

FIG. 21 illustrates an exemplary video_signal_info( ) syntax.

### DESCRIPTION OF EMBODIMENTS

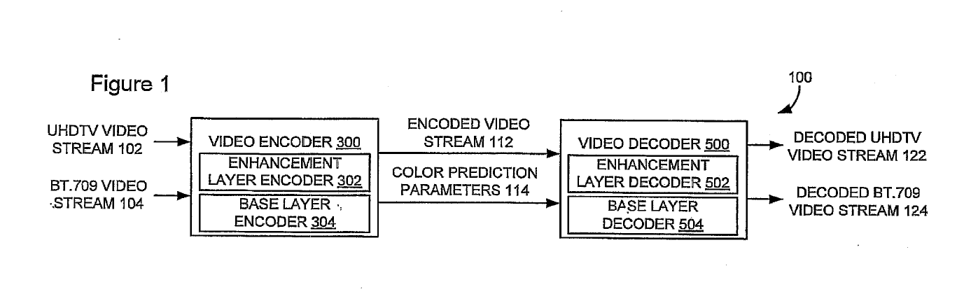

FIG. 1 is a block diagram example of a video coding system 100. The video coding system 100 can include a video encoder 300 to receive video streams, such as an Ultra High Definition Television (UHDTV) video stream 102, standardized as BT.2020, and a BT.709 video stream 104, and to generate an encoded video stream 112 based on the video streams. The video encoder 300 can transmit the encoded video stream 112 to a video decoder 500. The video decoder 500 can decode the encoded video stream 112 to generate a decoded UHDTV video stream 122 and/or a decoded BT.709 video stream 124.

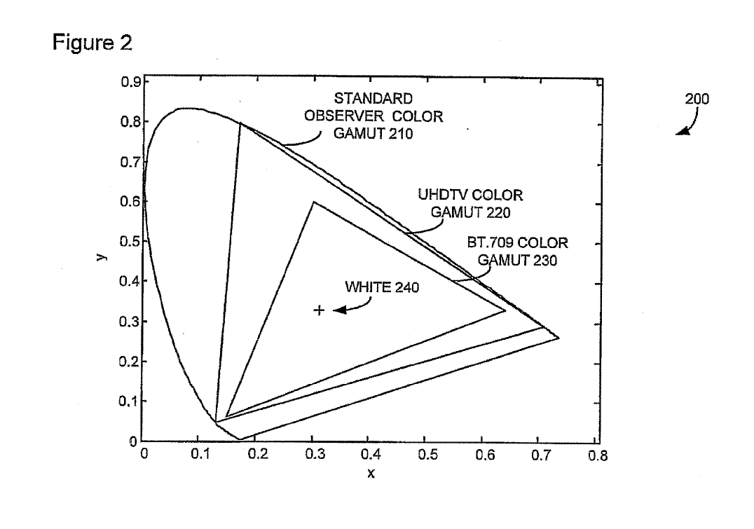

The UHDTV video stream 102 can have a different resolution, different quantization bit-depth, and represent different color gamut compared to the BT.709 video stream 104. For example, a UHDTV or BT.2020 video standard has a format recommendation that can support a 4k (3840×2160 pixels) or an 8k (7680×4320 pixels) resolution and a 10 or 12 bit quantization bit-depth. The BT.709 video standard has a format recommendation that can support a 2k (1920×1080 pixels) resolution and an 8 or 10 bit quantization bit-depth. The UHDTV format recommendation also can support a wider color gamut than the BT.709 format recommendation. Embodiments of the color gamut difference between the UHDTV video standard and the BT.709 video standard will be shown and described below in greater detail with reference to FIG. 2.

The video encoder 300 can include an enhancement layer encoder 302 and a base layer encoder 304. The base layer encoder 304 can implement video encoding for High Definition (HD) content, for example, with a codec implementing a Moving Picture Experts Group (MPEG)-2 standard, or the like. The enhancement layer encoder 302 can implement video encoding for UHDTV content. In some embodiments, the enhancement layer encoder 302 can encode an UHDTV video frame by generating a prediction of at least a portion of the UHDTV image frame using a motion compensation prediction, an intra-frame prediction, and a scaled color prediction from a BT.709 image frame encoded in the base layer encoder 302. The video encoder 300 can utilize the prediction to generate a prediction residue, for example, a difference between the prediction and the UHDTV image frame, and encode the prediction residue in the encoded video stream 112.

In some embodiments, when the video encoder 300 utilizes a scaled color prediction from the BT.709 image frame, the video encoder 300 can transmit color prediction parameters 114 to the video decoder 500. The color prediction parameters 114 can include parameters utilized by the video encoder 300 to generate the scaled color prediction. For example, the video encoder 300 can generate the scaled color prediction through an independent color channel prediction or an affine matrix-based color prediction, each having different parameters, such as a gain parameter per channel or a gain parameter and an offset parameter per channel. The color prediction parameters 114 can include parameters corresponding to the independent color channel prediction or the affine matrix-based color prediction utilized by the video encoder 300. In some embodiments, the encoder 300 can include the color prediction parameters 114 in a normative portion of the encoded video stream 112, for example, in a Sequence Parameter Set (SPS), a Picture Parameter Set (PPS), or another lower level section of the normative portion of the encoded video stream 112. In some embodiments, the video encoder 300 can utilize default color prediction parameters 114, which may be preset in the video decoder 500, alleviating the video encoder 300 from having to transmit color prediction parameters 114 to the video decoder 500. Embodiments of video encoder 300 will be described below in greater detail.

The video decoder 500 can include an enhancement layer decoder 502 and a base layer decoder 504. The base layer decoder 504 can implement video decoding for High Definition (HD) content, for example, with a codec implementing a Moving Picture Experts Group (MPEG)-2 standard, or the like, and decode the encoded video stream 112 to generate a decoded BT.709 video stream 124. The enhancement layer decoder 502 can implement video decoding for UHDTV content and decode the encoded video stream 112 to generate a decoded UHDTV video stream 122.

In some embodiments, the enhancement layer decoder 502 can decode at least a portion of the encoded video stream 112 into the prediction residue of the UHDTV video frame. The enhancement layer decoder 502 can generate a same or a similar prediction of the UHDTV image frame that was generated by the video encoder 300 during the encoding process, and then combine the prediction with the prediction residue to generate the decoded UHDTV video stream 122. The enhancement layer decoder 502 can generate the prediction of the UHDTV image frame through motion compensation prediction, intra-frame prediction, or scaled color prediction from a BT.709 image frame decoded in the base layer decoder 504. Embodiments of video encoder 400 will be described below in greater detail.

Although FIG. 1 shows color prediction-based video coding of an UHDTV video stream and a BT.709 video stream with video encoder 300 and video decoder 500, in some embodiments, any video streams representing different color gamuts can be encoded or decoded with color prediction-based video coding.

FIG. 2 is an example graph 200 illustrating color gamuts supported in a BT.709 video standard and in a UHDTV video standard. Referring to FIG. 2, the graph 200 shows a two-dimensional representation of color gamuts in an International Commission on Illumination (CIE) 1931 chrominance xy diagram format. The graph 200 includes a standard observer color gamut 210 to represent a range of colors viewable by a standard human observer as determined by the CIE in 1931. The graph 200 includes a UHDTV color gamut 220 to represent a range of colors supported the UHDTV video standard. The graph 200 includes a BT.709 color gamut 230 to represent a range of colors supported the BT.709 video standard, which is narrower than the UHDTV color gamut 220. The graph also includes a point that represents the color white 240, which is included in the standard observer color gamut 210, the UHDTV color gamut 220, and the BT.709 color gamut 230.

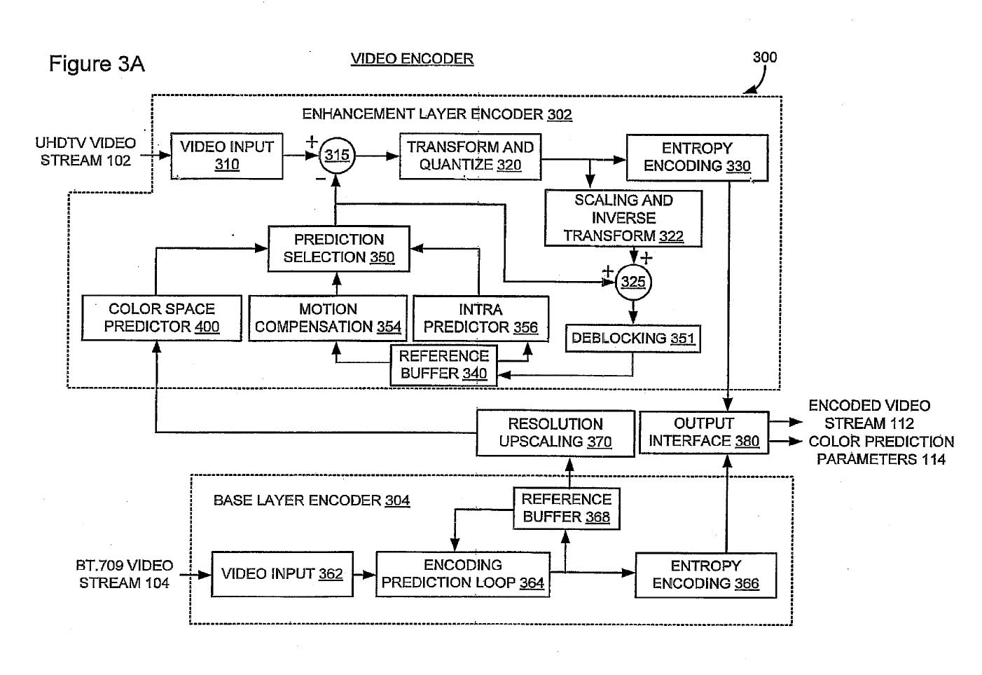

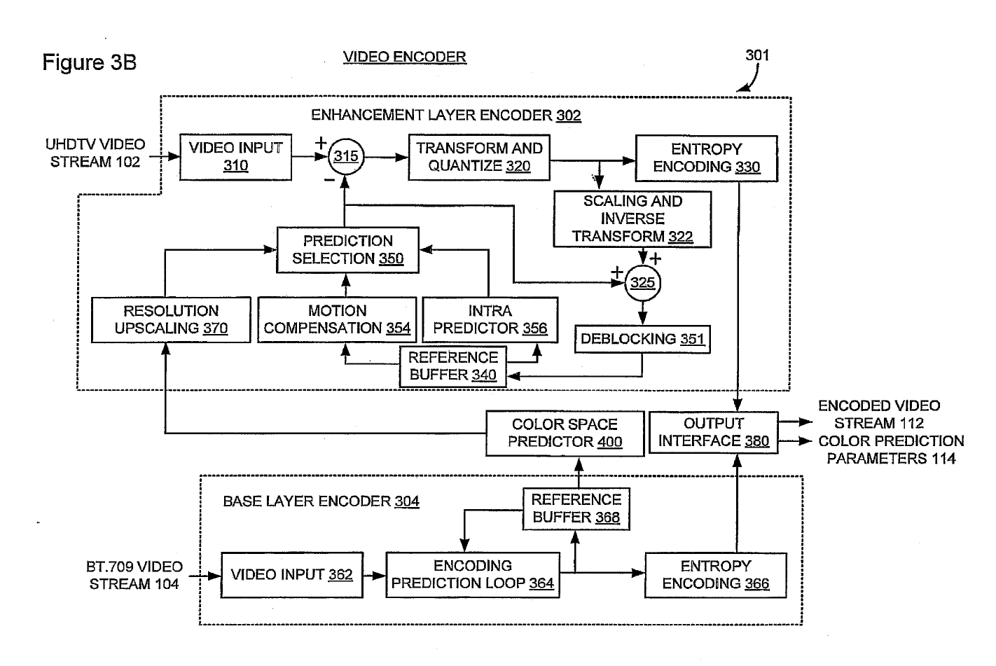

FIGS. 3A and 3B are block diagram examples of the video encoder 300 shown in FIG. 1. Referring to FIG. 3A, the video encoder 300 can include an enhancement layer encoder 302 and a base layer encoder 304. The base layer encoder 304 can include a video input 362 to receive a BT.709 video stream 104 having HD image frames. The base layer encoder 304 can include an encoding prediction loop 364 to encode the BT.709 video stream 104 received from the video input 362, and store the reconstructed frames of the BT.709 video stream in a reference buffer 368. The reference buffer 368 can provide the reconstructed BT.709 image frames back to the encoding prediction loop 364 for use in encoding other portions of the same frame or other frames of the BT.709 video stream 104. The reference buffer 368 can store the image frames encoded by the encoding prediction loop 364. The base layer encoder 304 can include entropy encoding function 366 to perform entropy encoding operations on the encoded-version of the BT.709 video stream from the encoding prediction loop 364 and provide an entropy encoded stream to an output interface 380.

The enhancement layer encoder 302 can include a video input 310 to receive a UHDTV video stream 102 having UHDTV image frames. The enhancement layer encoder 302 can generate a prediction of the UHDTV image frames and utilize the prediction to generate a prediction residue, for example, a difference between the prediction and the UHDTV image frames determined with a combination function 315. In some embodiments, the combination function 315 can include weighting, such as linear weighting, to generate the prediction residue from the prediction of the UHDTV image frames. The enhancement layer encoder 302 can transform and quantize the prediction residue with a transform and quantize function 320. An entropy encoding function 330 can encode the output of the transform and quantize function 320, and provide an entropy encoded stream to the output interface 380. The output interface 380 can multiplex the entropy encoded streams from the entropy encoding functions 366 and 330 to generate the encoded video stream 112.

The enhancement layer encoder 302 can include a color space predictor 400, a motion compensation prediction function 354, and an intra predictor 356, each of which can generate a prediction of the UHDTV image frames. The enhancement layer encoder 302 can include a prediction selection function 350 to select a prediction generated by the color space predictor 400, the motion compensation prediction function 354, and/or the intra predictor 356 to provide to the combination function 315.

In some embodiments, the motion compensation prediction function 354 and the intra predictor 356 can generate their respective predictions based on UHDTV image frames having previously been encoded and decoded by the enhancement layer encoder 302. For example, after a prediction residue has been transformed and quantized, the transform and quantize function 320 can provide the transformed and quantized prediction residue to a scaling and inverse transform function 322, the result of which can be combined in a combination function 325 with the prediction utilized to generate the prediction residue and generate a decoded UHDTV image frame. The combination function 325 can provide the decoded UHDTV image frame to a deblocking function 351, and the deblocking function 351 can store the decoded UHDTV image frame in a reference buffer 340, which holds the decoded UHDTV image frame for use by the motion compensation prediction function 354 and the intra predictor 356. In some embodiments, the deblocking function 351 can filter the decoded UHDTV image frame, for example, to smooth sharp edges in the image between macroblocks corresponding to the decoded UHDTV image frame.

The motion compensation prediction function 354 can receive one or more decoded UHDTV image frames from the reference buffer 340. The motion compensation prediction function 354 can generate a prediction of a current UHDTV image frame based on image motion between the one or more decoded UHDTV image frames from the reference buffer 340 and the UHDTV image frame.

The intra predictor 356 can receive a first portion of a current UHDTV image frame from the reference buffer 340. The intra predictor 356 can generate a prediction corresponding to a first portion of a current UHDTV image frame based on at least a second portion of the current UHDTV image frame having previously been encoded and decoded by the enhancement layer encoder 302.

The color space predictor 400 can generate a prediction of the UHDTV image frames based on BT.709 image frames having previously been encoded by the base layer encoder 304. In some embodiments, the reference buffer 368 in the base layer encoder 304 can provide the reconstructed BT.709 image frame to a resolution upscaling function 370, which can scale the resolution of the reconstructed BT.709 image frame to a resolution that corresponds to the UHDTV video stream 102. The resolution upscaling function 370 can provide an upscaled resolution version of the reconstructed BT.709 image frame to the color space predictor 400. The color space predictor can generate a prediction of the UHDTV image frame based on the upscaled resolution version of the reconstructed BT.709 image frame. In some embodiments, the color space predictor 400 can scale a YUV color space of the upscaled resolution version of the reconstructed BT.709 image frame to correspond to the YUV representation supported by the UHDTV video stream 102.

There are several ways for the color space predictor 400 to scale the color space supported by BT.709 video coding standard to a color space supported by the UHDTV video stream 102, such as independent channel prediction and affine mixed channel prediction. Independent channel prediction can include converting each portion of the YUV color space for the BT.709 image frame separately into the prediction of the UHDTV image frame. The Y portion or luminance can be scaled according to Equation 1:

Y_{UHDTV}=g₁·Y_{BT.709}+o₁

The U portion or one of the chrominance portions can be scaled according to Equation 2:

U_{UHDTV}=g₂·U_{BT.709}+o₂

The V portion or one of the chrominance portions can be scaled according to Equation 3:

V_{UHDTV}=g₃·V_{BT.709}+o₃

The gain parameters g1, g2, and g3 and the offset parameters o1, o2, and o3 can be based on differences in the color space supported by the BT.709 video coding standard and the UHDTV video standard, and may vary depending on the content of the respective BT.709 image frame and UHDTV image frame. The enhancement layer encoder 304 can output the gain parameters g1, g2, and g3 and the offset parameters o1, o2, and o3 utilized by the color space predictor 400 to generate the prediction of the UHDTV image frame to the video decoder 500 as the color prediction parameters 114, for example, via the output interface 380.

In some embodiments, the independent channel prediction can include gain parameters g1, g2, and g3, and zero parameters. The Y portion or luminance can be scaled according to Equation 4:

Y_{UHDTV}=g₁·(Y_{BT.709}−Yzero_{BT.709})+Yzero_{UHDTV}

The U portion or one of the chrominance portions can be scaled according to Equation 5:

U_{UHDTV}=g₂·(U_{BT.709}−Uzero_{BT.709})+Uzero_{UHDTV}

The V portion or one of the chrominance portions can be scaled according to Equation 6:

V_{UHDTV}=g₃·(V_{BT.709}−Vzero_{BT.709})+Vzero_{UHDTV}

The gain parameters g1, g2, and g3 can be based on differences in the color space supported by the BT.709 video coding standard and the UHDTV video standard, and may vary depending on the content of the respective BT.709 image frame and UHDTV image frame. The enhancement layer encoder 304 can output the gain parameters g1, g2, and g3 utilized by the color space predictor 400 to generate the prediction of the UHDTV image frame to the video decoder 500 as the color prediction parameters 114, for example, via the output interface 380. Since the video decoder 500 can be preloaded with the zero parameters, the video encoder 300 can generate and transmit fewer color prediction parameters 114, for example, three instead of six, to the video decoder 500.

In some embodiments, the zero parameters used in Equations 4-6 can be defined based on the bit-depth of the relevant color space and color channel. For example, in Table 1, the zero parameters can be defined as follows:

TABLE 1

| | |
|---|---|
| Yzero_{BT.709} = 0 | Yzero_{UHDTV} = 0 |
| Uzero_{BT.709} = (1 << bits_{BT.709}) | Uzero_{UHDTV} = (1 << bits_{UHDTV}) |
| Vzero_{BT.709} = (1 << bits_{BT.709}) | Vzero_{UHDTV} = (1 << bits_{UHDTV}) |

The affine mixed channel prediction can include converting the YUV color space for a BT.709 image frame by mixing the YUV channels of the BT.709 image frame to generate a prediction of the UHDTV image frame, for example, through a matrix multiplication function. In some embodiments, the color space of the BT.709 can be scaled according to Equation 7:

$${( \begin{matrix}Y \\ U \\ V\end{matrix} )}_{UHDTV} = ( \begin{matrix}{m}_{11} & {m}_{12} & {m}_{13} \\ {m}_{21} & {m}_{22} & {m}_{23} \\ {m}_{31} & {m}_{32} & {m}_{33}\end{matrix} ) \cdot {( \begin{matrix}Y \\ U \\ V\end{matrix} )}_{BT \cdot 709} + ( \begin{matrix}{o}_{1} \\ {o}_{2} \\ {o}_{3}\end{matrix} )$$

The matrix parameters m11, m12, m13, m21, m22, m23, m31, m32, and m33 and the offset parameters o1, o2, and o3 can be based on the difference in color space supported by the BT.709 video format recommendation and the UHDTV video format recommendation, and may vary depending on the content of the respective BT.709 image frame and UHDTV image frame. The enhancement layer encoder 304 can output the matrix and offset parameters utilized by the color space predictor 400 to generate the prediction of the UHDTV image frame to the video decoder 500 as the color prediction parameters 114, for example, via the output interface 380.

In some embodiments, the color space of the BT.709 can be scaled according to Equation 8:

$${( \begin{matrix}Y \\ U \\ V\end{matrix} )}_{UHDTV} = ( \begin{matrix}{m}_{11} & {m}_{12} & {m}_{13} \\ 0 & {m}_{22} & 0 \\ 0 & 0 & {m}_{33}\end{matrix} ) \cdot {( \begin{matrix}Y \\ U \\ V\end{matrix} )}_{BT \cdot 709} + ( \begin{matrix}{o}_{1} \\ {o}_{2} \\ {o}_{3}\end{matrix} )$$

The matrix parameters m11, m12, m13, m22, and m33 and the offset parameters o1, o2, and o3 can be based on the difference in color space supported by the BT.709 video coding standard and the UHDTV video standard, and may vary depending on the content of the respective BT.709 image frame and UHDTV image frame. The enhancement layer encoder 304 can output the matrix and offset parameters utilized by the color space predictor 400 to generate the prediction of the UHDTV image frame to the video decoder 500 as the color prediction parameters 114, for example, via the output interface 380.

By replacing the matrix parameters m21, m23, m31, and m32 with zero, the luminance channel Y of the UHDTV image frame prediction can be mixed with the color channels U and V of the BT.709 image frame, but the color channels U and V of the UHDTV image frame prediction may not be mixed with the luminance channel Y of the BT.709 image frame. The selective channel mixing can allow for a more accurate prediction of the luminance channel UHDTV image frame prediction, while reducing a number of prediction parameters 114 to transmit to the video decoder 500.

In some embodiments, the color space of the BT.709 can be scaled according to Equation 9:

$${( \begin{matrix}Y \\ U \\ V\end{matrix} )}_{UHDTV} = ( \begin{matrix}{m}_{11} & {m}_{12} & {m}_{13} \\ 0 & {m}_{22} & {m}_{23} \\ 0 & {m}_{32} & {m}_{33}\end{matrix} ) \cdot {( \begin{matrix}Y \\ U \\ V\end{matrix} )}_{BT \cdot 709} + ( \begin{matrix}{o}_{1} \\ {o}_{2} \\ {o}_{3}\end{matrix} )$$

The matrix parameters m11, m12, m13, m22, m23, m32, and m33 and the offset parameters o1, o2, and o3 can be based on the difference in color space supported by the BT.709 video standard and the UHDTV video standard, and may vary depending on the content of the respective BT.709 image frame and UHDTV image frame. The enhancement layer encoder 304 can output the matrix and offset parameters utilized by the color space predictor 400 to generate the prediction of the UHDTV image frame to the video decoder 500 as the color prediction parameters 114, for example, via the output interface 380.

By replacing the matrix parameters m21 and m31 with zero, the luminance channel Y of the UHDTV image frame prediction can be mixed with the color channels U and V of the BT.709 image frame. The U and V color channels of the UHDTV image frame prediction can be mixed with the U and V color channels of the BT.709 image frame, but not the luminance channel Y of the BT.709 image frame. The selective channel mixing can allow for a more accurate prediction of the luminance channel UHDTV image frame prediction, while reducing a number of prediction parameters 114 to transmit to the video decoder 500.

The color space predictor 400 can generate the scaled color space predictions for the prediction selection function 350 on a per sequence (inter-frame), a per frame, or a per slice (intra-frame) basis, and the video encoder 300 can transmit the prediction parameter 114 corresponding to the scaled color space predictions on a per sequence (inter-frame), a per frame, or a per slice (intra-frame) basis. In some embodiments, the granularity for generating the scaled color space predictions can be preset or fixed in the color space predictor 400 or dynamically adjustable by the video encoder 300 based on encoding function or the content of the UHDTV image frames.

The video encoder 300 can transmit the color prediction parameters 114 in a normative portion of the encoded video stream 112, for example, in a Sequence Parameter Set (SPS), a Picture Parameter Set (PPS), or another lower level section of the normative portion of the encoded video stream 112. In some embodiments, the color prediction parameters 114 can be inserted into the encoded video stream 112 with a syntax that allows the video decoder 500 to identify that the color prediction parameters 114 are present in the encoded video stream 112, to identify a precision or size of the parameters, such as a number of bits utilized to represent each parameter, and identify a type of color space prediction the color space predictor 400 of the video encoder 300 utilized to generate the color space prediction.

In some embodiments, the normative portion of the encoded video stream 112 can include a flag (use_color_space_prediction), for example, one or more bits, which can annunciate an inclusion of color space parameters 114 in the encoded video stream 112. The normative portion of the encoded video stream 112 can include a size parameter (color_predictor_num_fraction_bits_minus1), for example, one or more bits, which can identify a number of bits or precision utilized to represent each parameter. The normative portion of the encoded video stream 112 can include a predictor type parameter (color_predictor_idc), for example, one or more bits, which can identify a type of color space prediction utilized by the video encoder 300 to generate the color space prediction. The types of color space prediction can include independent channel prediction, affine prediction, their various implementations, or the like. The color prediction parameters 114 can include gain parameters, offset parameters, and/or matrix parameters depending on the type of prediction utilized by the video encoder 300.

Referring to FIG. 3B, a video encoder 301 can be similar to video encoder 300 shown and described above in FIG. 3A with the following differences. The video encoder 301 can switch the color space predictor 400 with the resolution upscaling function 370. The color space predictor 400 can generate a prediction of the UHDTV image frames based on BT.709 image frames having previously been encoded by the base layer encoder 304.

In some embodiments, the reference buffer 368 in the base layer encoder 304 can provide the encoded BT.709 image frame to the color space predictor 400. The color space predictor can scale a YUV color space of the encoded BT.709 image frame to correspond to the YUV representation supported by the UHDTV video format. The color space predictor 400 can provide the color space prediction to a resolution upscaling function 370, which can scale the resolution of the color space prediction of the encoded BT.709 image frame to a resolution that corresponds to the UHDTV video format. The resolution upscaling function 370 can provide a resolution upscaled color space prediction to the prediction selection function 350.

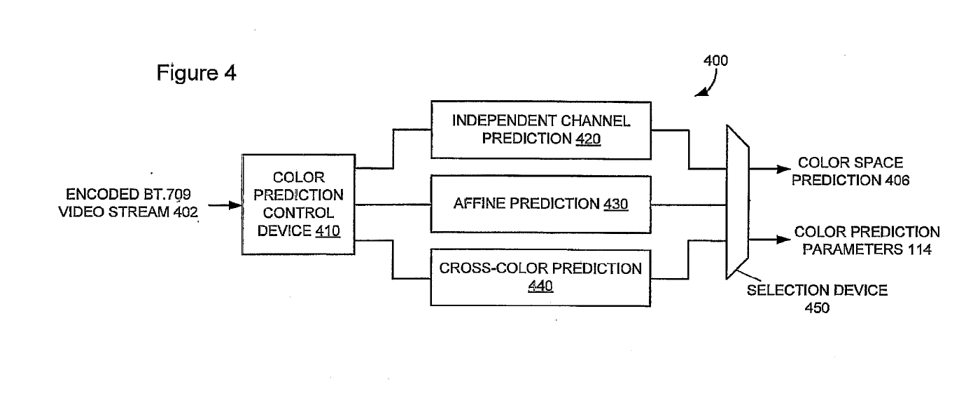

FIG. 4 is a block diagram example of the color space predictor 400 shown in FIG. 3A. Referring to FIG. 4, the color space predictor 400 can include a color space prediction control device 410 to receive a reconstructed BT.709 video frame 402, for example, from a base layer encoder 304 via a resolution upscaling function 370, and select a prediction type and timing for a generation for a color space prediction 406. In some embodiments, the color space prediction control device 410 can pass the reconstructed BT.709 video frame 402 to at least one of an independent channel prediction function 420, an affine prediction function 430, or a cross-color prediction function 440. Each of the prediction functions 420, 430, and 440 can generate a color space prediction of a UHDTV image frame (or portion thereof) from the reconstructed BT.709 video frame 402, for example, by scaling the color space of a BT.709 image frame to a color space of the UHDTV image frame.

The independent color channel prediction function 420 can scale YUV components of the encoded BT.709 video stream 402 separately, for example, as shown above in Equations 1-6. The affine prediction function 430 can scale YUV components of the reconstructed BT.709 video frame 402 with a matrix multiplication, for example, as shown above in Equation 7. The cross-color prediction function 440 can scale YUV components of the encoded BT.709 video stream 402 with a modified matrix multiplication that can eliminate mixing of a Y component from the encoded BT.709 video stream 402 when generating the U and V components of the UHDTV image frame, for example, as shown above in Equations 8 or 9.

In some embodiments, the color space predictor 400 can include a selection device 450 to select an output from the independent color channel prediction function 420, the affine prediction function 430, and the cross-color prediction function 440. The selection device 450 also can output the color prediction parameters 114 utilized to generate the color space prediction 406. The color prediction control device 410 can control the timing of the generation of the color space prediction 406 and the type of operation performed to generate the color space prediction 406, for example, by controlling the timing and output of the selection device 450. In some embodiments, the color prediction control device 410 can control the timing of the generation of the color space prediction 406 and the type of operation performed to generate the color space prediction 406 by selectively providing the encoded BT.709 video stream 402 to at least one of the independent color channel prediction function 420, the affine prediction function 430, and the cross-color prediction function 440.

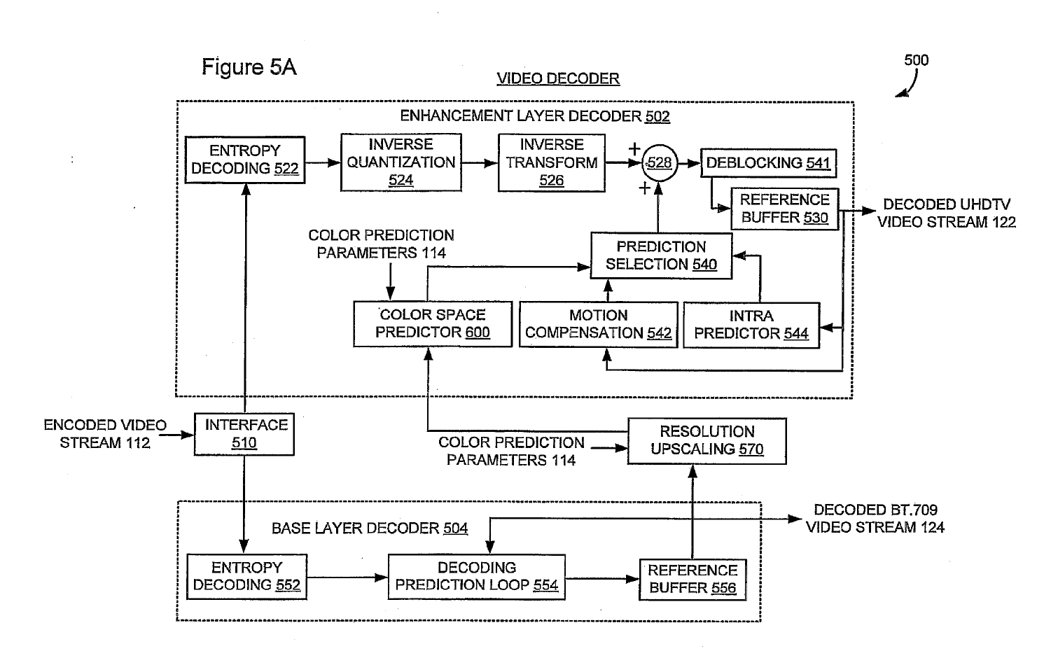

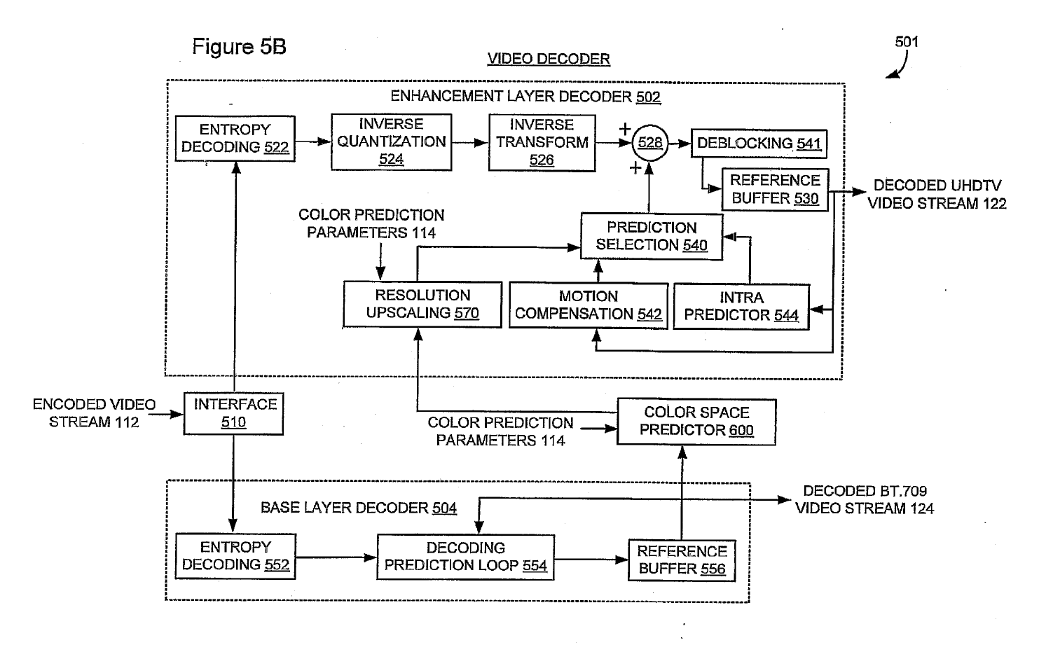

FIGS. 5A and 5B are block diagram examples of the video decoder 500 shown in FIG. 1. Referring to FIG. 5A, the video decoder can include an interface 510 to receive the encoded video stream 112, for example, from a video encoder 300. The interface 510 can demultiplex the encoded video stream 112 and provide encoded UHDTV image data to an enhancement layer decoder 502 of the video decoder 500 and provide encoded BT.709 image data to a base layer decoder 504 of the video decoder 500. The base layer decoder 504 can include an entropy decoding function 552 and a decoding prediction loop 554 to decode encoded BT.709 image data received from the interface 510, and store the decoded BT.709 video stream 124 in a reference buffer 556. The reference buffer 556 can provide the decoded BT.709 video stream 124 back to the decoding prediction loop 554 for use in decoding other portions of the same frame or other frames of the encoded BT.709 image data. The base layer decoder 504 can output the decoded BT.709 video stream 124. In some embodiments, the output from the decoding prediction loop 554 and input to the reference buffer 556 may be residual frame data rather than the reconstructed frame data.

The enhancement layer decoder 502 can include an entropy decoding function 522, a inverse quantization function 524, an inverse transform function 526, and a combination function 528 to decode the encoded UHDTV image data received from the interface 510. A deblocking function 541 can filter the decoded UHDTV image frame, for example, to smooth sharp edges in the image between macroblocks corresponding to the decoded UHDTV image frame, and store the decoded UHDTV video stream 122 in a reference buffer 530. In some embodiments, the encoded UHDTV image data can correspond to a prediction residue, for example, a difference between a prediction and a UHDTV image frame as determined by the video encoder 300. The enhancement layer decoder 502 can generate a prediction of the UHDTV image frame, and the combination function 528 can add the prediction of the of the UHDTV image frame to encoded UHDTV image data having undergone entropy decoding, inverse quantization, and an inverse transform to generate the decoded UHDTV video stream 122. In some embodiments, the combination function 528 can include weighting, such as linear weighting, to generate the decoded UHDTV video stream 122.

The enhancement layer decoder 502 can include a color space predictor 600, a motion compensation prediction function 542, and an intra predictor 544, each of which can generate the prediction of the UHDTV image frame. The enhancement layer decoder 502 can include a prediction selection function 540 to select a prediction generated by the color space predictor 600, the motion compensation prediction function 542, and/or the intra predictor 544 to provide to the combination function 528.

In some embodiments, the motion compensation prediction function 542 and the intra predictor 544 can generate their respective predictions based on UHDTV image frames having previously been decoded by the enhancement layer decoder 502 and stored in the reference buffer 530. The motion compensation prediction function 542 can receive one or more decoded UHDTV image frames from the reference buffer 530. The motion compensation prediction function 542 can generate a prediction of a current UHDTV image frame based on image motion between the one or more decoded UHDTV image frames from the reference buffer 530 and the UHDTV image frame.

The intra predictor 544 can receive a first portion of a current UHDTV image frame from the reference buffer 530. The intra predictor 544 can generate a prediction corresponding to a first portion of a current UHDTV image frame based on at least a second portion of the current UHDTV image frame having previously been decoded by the enhancement layer decoder 502.

The color space predictor 600 can generate a prediction of the UHDTV image frames based on BT.709 image frames decoded by the base layer decoder 504. In some embodiments, the reference buffer 556 in the base layer decoder 504 can provide a portion of the decoded BT.709 video stream 124 to a resolution upscaling function 570, which can scale the resolution of the encoded BT.709 image frame to a resolution that corresponds to the UHDTV video format. The resolution upscaling function 570 can provide an upscaled resolution version of the encoded BT.709 image frame to the color space predictor 600. The color space predictor can generate a prediction of the UHDTV image frame based on the upscaled resolution version of the encoded BT.709 image frame. In some embodiments, the color space predictor 600 can scale a YUV color space of the upscaled resolution version of the encoded BT.709 image frame to correspond to the YUV representation supported by the UHDTV video format.

The color space predictor 600 can operate similarly to the color space predictor 400 in the video encoder 300, by scaling the color space supported by BT.709 video coding standard to a color space supported by the UHDTV video format, for example, with independent channel prediction, affine mixed channel prediction, or cross-color channel prediction. The color space predictor 600, however, can select a type of color space prediction to generate based, at least in part, on the color prediction parameters 114 received from the video encoder 300. The color prediction parameters 114 can explicitly identify a particular a type of color space prediction, or can implicitly identify the type of color space prediction, for example, by a quantity and/or arrangement of the color prediction parameters 114.

As discussed above, in some embodiments, the normative portion of the encoded video stream 112 can include a flag (use_color_space_prediction), for example, one or more bits, which can annunciate an inclusion of color space parameters 114 in the encoded video stream 112. The normative portion of the encoded video stream 112 can include a size parameter (color_predictor_num_fraction_bits_minus1), for example, one or more bits, which can identify a number of bits or precision utilized to represent each parameter. The normative portion of the encoded video stream 112 can include a predictor type parameter (color_predictor_idc), for example, one or more bits, which can identify a type of color space prediction utilized by the video encoder 300 to generate the color space prediction. The types of color space prediction can include independent channel prediction, affine prediction, their various implementations, or the like. The color prediction parameters 114 can include gain parameters, offset parameters, and/or matrix parameters depending on the type of prediction utilized by the video encoder 300.

The color space predictor 600 identify whether the video encoder 300 utilize color space prediction in generating then encoded video stream 112 based on the flag (use_color_space_prediction). When color prediction parameters 114 are present in the encoded video stream 112, the color space predictor 600 can parse the color prediction parameters 114 to identify a type of color space prediction utilized by the video encoded based on the predictor type parameter (color_predictor_idc), and a size or precision of the parameters (color_predictor_num_fraction_bits_minus1), and locate the color space parameters to utilize to generate a color space prediction.

For example, the video decoder 500 can determine whether the color prediction parameters 114 are present in the encoded video stream 112 and parse the color prediction parameters 114 based on the following example code in Table 2:

TABLE 2

```
use_color_space_prediction
if(use_color_space_prediction) {
  color_predictor_num_fraction_bits_minus1
  color_prediction_idc
  if(color_prediction_idc==0) {
    for( i = 0; i < 3; i++ ){
      color_predictor_gain [ i ]
    }
  }
  if(color_prediction_idc==1) {
    for( i = 0; i < 3; i++ ){
      color_predictor_gain [ i ]
      color_predictor_offset [ i ]
    }
  }
  if(color_prediction_idc==2) {
    for( i = 0; i < 3; i++ ){
      for( j= 0; j < 3; j++ ){
        cross_color_predictor_gain [ i ][j]
      }
      color_predictor_offset [ i ]
    }
  }
```

The example code in Table 2 can allow the video decoder 500 to identify whether color prediction parameters 114 are present in the encoded video stream 112 based on the use_color_space_prediction flag. The video decoder 500 can identify the precision or size of the color space parameters based on the size parameter (color_predictor_num_fraction_bits_minus1), and can identify a type of color space prediction utilized by the video encoder 300 based on the type parameter (color_predictor_idc). The example code in Table 2 can allow the video decoder 500 to parse the color space parameters from the encoded video stream 112 based on the identified size of the color space parameters and the identified type color space prediction utilized by the video encoder 300, which can identify the number, semantics, and location of the color space parameters. Although the example code in Table 2 shows the affine prediction including 9 matrix parameters and 3 offset parameters, in some embodiments, the color prediction parameters 114 can include fewer matrix and/or offset parameters, for example, when the matrix parameters are zero, and the example code can be modified to parse the color prediction parameters 114 accordingly.

The color space predictor 600 can generate color space predictions for the prediction selection function 540 on a per sequence (inter-frame), a per frame, or a per slice (intra-frame) basis. In some embodiments, the color space predictor 600 can generate the color space predictions with a fixed or preset timing or dynamically in response to a reception of the color prediction parameters 114 from the video encoder 300.

Referring to FIG. 5B, a video decoder 501 can be similar to video decoder 500 shown and described above in FIG. 5A with the following differences. The video decoder 501 can switch the color space predictor 600 with the resolution upscaling function 570. The color space predictor 600 can generate a prediction of the UHDTV image frames based on portions of the decoded BT.709 video stream 124 from the base layer decoder 504.

In some embodiments, the reference buffer 556 in the base layer decoder 504 can provide the portions of the decoded BT.709 video stream 124 to the color space predictor 600. The color space predictor 600 can scale a YUV color space of the portions of the decoded BT.709 video stream 124 to correspond to the YUV representation supported by the UHDTV video standard. The color space predictor 600 can provide the color space prediction to a resolution upscaling function 570, which can scale the resolution of the color space prediction to a resolution that corresponds to the UHDTV video standard. The resolution upscaling function 570 can provide a resolution upscaled color space prediction to the prediction selection function 540.

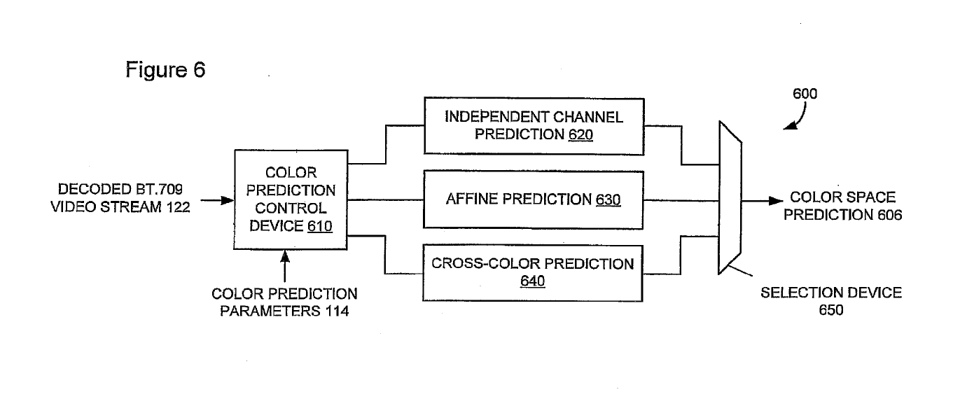

FIG. 6 is a block diagram example of a color space predictor 600 shown in FIG. 5A. Referring to FIG. 6, the color space predictor 600 can include a color space prediction control device 610 to receive the decoded BT.709 video stream 122, for example, from a base layer decoder 504 via a resolution upscaling function 570, and select a prediction type and timing for a generation for a color space prediction 606. The color space predictor 600 can select a type of color space prediction to generate based, at least in part, on the color prediction parameters 114 received from the video encoder 300. The color prediction parameters 114 can explicitly identify a particular a type of color space prediction, or can implicitly identify the type of color space prediction, for example, by a quantity and/or arrangement of the color prediction parameters 114. In some embodiments, the color space prediction control device 610 can pass the decoded BT.709 video stream 122 and color prediction parameters 114 to at least one of an independent channel prediction function 620, an affine prediction function 630, or a cross-color prediction function 640. Each of the prediction functions 620, 630, and 640 can generate a color space prediction of a UHDTV image frame (or portion thereof) from the decoded BT.709 video stream 122, for example, by scaling the color space of a BT.709 image frame to a color space of the UHDTV image frame based on the color space parameters 114.

The independent color channel prediction function 620 can scale YUV components of the decoded BT.709 video stream 122 separately, for example, as shown above in Equations 1-6. The affine prediction function 630 can scale YUV components of the decoded BT.709 video stream 122 with a matrix multiplication, for example, as shown above in Equation 7. The cross-color prediction function 640 can scale YUV components of the decoded BT.709 video stream 122 with a modified matrix multiplication that can eliminate mixing of a Y component from the decoded BT.709 video stream 122 when generating the U and V components of the UHDTV image frame, for example, as shown above in Equations 8 or 9.

In some embodiments, the color space predictor 600 can include a selection device 650 to select an output from the independent color channel prediction function 620, the affine prediction function 630, and the cross-color prediction function 640. The color prediction control device 610 can control the timing of the generation of the color space prediction 606 and the type of operation performed to generate the color space prediction 606, for example, by controlling the timing and output of the selection device 650. In some embodiments, the color prediction control device 610 can control the timing of the generation of the color space prediction 606 and the type of operation performed to generate the color space prediction 606 by selectively providing the decoded BT.709 video stream 122 to at least one of the independent color channel prediction function 620, the affine prediction function 630, and the cross-color prediction function 640.

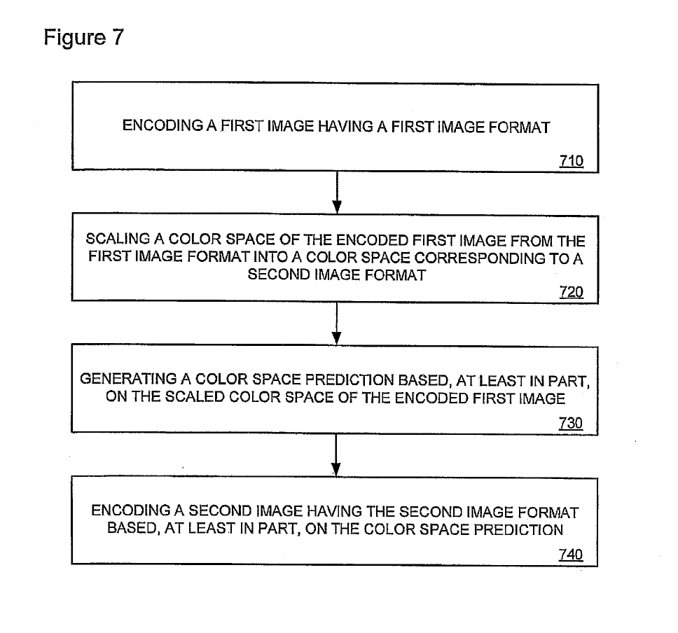

FIG. 7 is an example operational flowchart for color space prediction in the video encoder 300. Referring to FIG. 7, at a first block 710, the video encoder 300 can encode a first image having a first image format. In some embodiments, the first image format can correspond to a BT.709 video standard and the video encoder 300 can include a base layer to encode BT.709 image frames.

At a block 720, the video encoder 300 can scale a color space of the first image from the first image format into a color space corresponding to a second image format. In some embodiments, the video encoder 300 can scale the color space between the BT.709 video standard and an Ultra High Definition Television (UHDTV) video standard corresponding to the second image format.

There are several ways for the video encoder 300 to scale the color space supported by BT.709 video coding standard to a color space supported by the UHDTV video format, such as independent channel prediction and affine mixed channel prediction. For example, the independent color channel prediction can scale YUV components of encoded BT.709 image frames separately, for example, as shown above in Equations 1-6. The affine mixed channel prediction can scale YUV components of the encoded BT.709 image frames with a matrix multiplication, for example, as shown above in Equations 7-9.

In some embodiments, the video encoder 300 can scale a resolution of the first image from the first image format into a resolution corresponding to the second image format. For example, the UHDTV video standard can support a 4k (3840×2160 pixels) or an 8k (7680×4320 pixels) resolution and a 10 or 12 bit quantization bit-depth. The BT.709 video standard can support a 2k (1920×1080 pixels) resolution and an 8 or 10 bit quantization bit-depth. The video encoder 300 can scale the encoded first image from a resolution corresponding to the BT.709 video standard into a resolution corresponding to the UHDTV video standard.

At a block 730, the video encoder 300 can generate a color space prediction based, at least in part, on the scaled color space of the first image. The color space prediction can be a prediction of a UHDTV image frame (or portion thereof) from a color space of a corresponding encoded BT.709 image frame. In some embodiments, the video encoder 300 can generate the color space prediction based, at least in part, on the scaled resolution of the first image.

At a block 740, the video encoder 300 can encode a second image having the second image format based, at least in part, on the color space prediction. The video encoder 300 can output the encoded second image and color prediction parameters utilized to scale the color space of the first image to a video decoder.

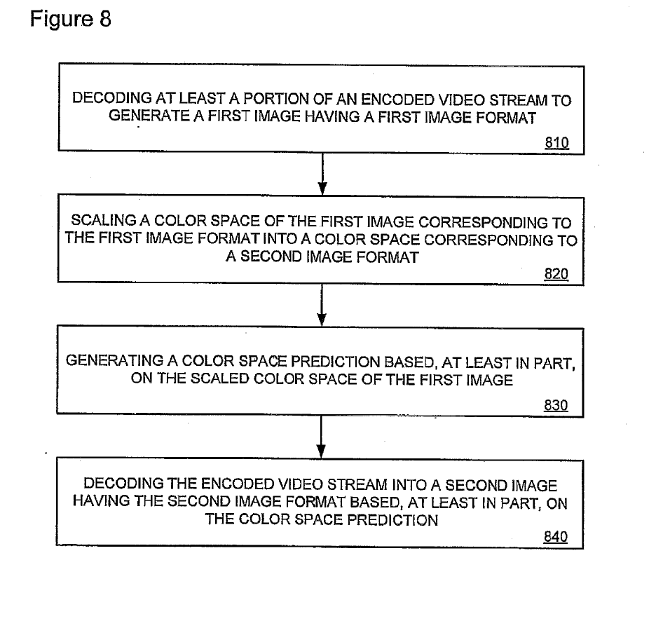

FIG. 8 is an example operational flowchart for color space prediction in the video decoder 500. Referring to FIG. 8, at a first block 810, the video decoder 500 can decode an encoded video stream to generate a first image having a first image format. In some embodiments, the first image format can correspond to a BT.709 video standard and the video decoder 500 can include a base layer to decode BT.709 image frames.

At a block 820, the video decoder 500 can scale a color space of the first image corresponding to the first image format into a color space corresponding to a second image format. In some embodiments, the video decoder 500 can scale the color space between the BT.709 video standard and an Ultra High Definition Television (UHDTV) video standard corresponding to the second image format.

There are several ways for the video decoder 500 to scale the color space supported by BT.709 video coding standard to a color space supported by the UHDTV video standard, such as independent channel prediction and affine mixed channel prediction. For example, the independent color channel prediction can scale YUV components of the encoded BT.709 image frames separately, for example, as shown above in Equations 1-6. The affine mixed channel prediction can scale YUV components of the encoded BT.709 image frames with a matrix multiplication, for example, as shown above in Equations 7-9.

The video decoder 500 can select a type of color space scaling to perform, such as independent channel prediction or one of the varieties of affine mixed channel prediction based on channel prediction parameters the video decoder 500 receives from the video encoder 300. In some embodiments, the video decoder 500 can perform a default or preset color space scaling of the decoded BT.709 image frames.

In some embodiments, the video decoder 500 can scale a resolution of the first image from the first image format into a resolution corresponding to the second image format. For example, the UHDTV video standard can support a 4k (3840×2160 pixels) or an 8k (7680×4320 pixels) resolution and a 10 or 12 bit quantization bit-depth. The BT.709 video standard can support a 2k (1920×1080 pixels) resolution and an 8 or 10 bit quantization bit-depth. The video decoder 500 can scale the decoded first image from a resolution corresponding to the BT.709 video standard into a resolution corresponding to the UHDTV video standard.

At a block 830, the video decoder 500 can generate a color space prediction based, at least in part, on the scaled color space of the first image. The color space prediction can be a prediction of a UHDTV image frame (or portion thereof) from a color space of a corresponding decoded BT.709 image frame. In some embodiments, the video decoder 500 can generate the color space prediction based, at least in part, on the scaled resolution of the first image.

At a block 840, the video decoder 500 can decode the encoded video stream into a second image having the second image format based, at least in part, on the color space prediction. In some embodiments, the video decoder 500 can utilize the color space prediction to combine with a portion of the encoded video stream corresponding to a prediction residue from the video encoder 300. The combination of the color space prediction and the decoded prediction residue can correspond to a decoded UHDTV image frame or portion thereof.

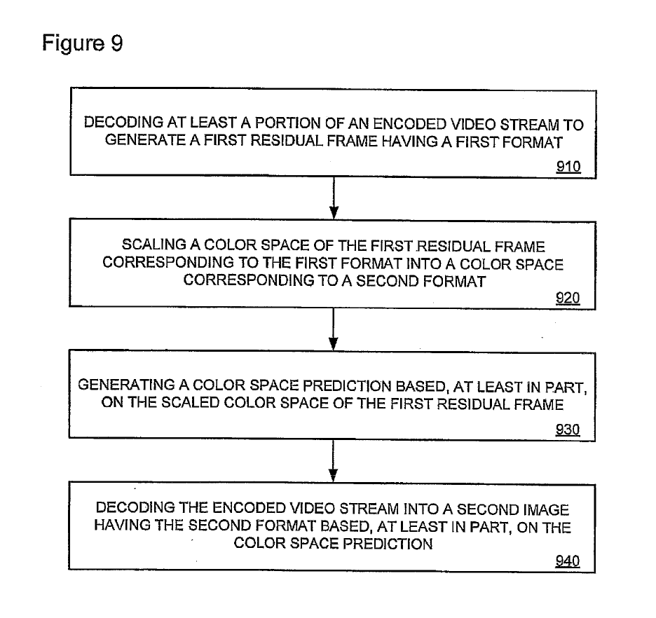

FIG. 9 is another example operational flowchart for color space prediction in the video decoder 500. Referring to FIG. 9, at a first block 910, the video decoder 500 can decode at least a portion of an encoded video stream to generate a first residual frame having a first format. The first residual frame can be a frame of data corresponding to a difference between two image frames. In some embodiments, the first format can correspond to a BT.709 video standard and the video decoder 500 can include a base layer to decode BT.709 image frames.

At a block 920, the video decoder 500 can scale a color space of the first residual frame corresponding to the first format into a color space corresponding to a second format. In some embodiments, the video decoder 500 can scale the color space between the BT.709 video standard and an Ultra High Definition Television (UHDTV) video standard corresponding to the second format.

There are several ways for the video decoder 500 to scale the color space supported by BT.709 video coding standard to a color space supported by the UHDTV video standard, such as independent channel prediction and affine mixed channel prediction. For example, the independent color channel prediction can scale YUV components of the encoded BT.709 image frames separately, for example, as shown above in Equations 1-6. The affine mixed channel prediction can scale YUV components of the encoded BT.709 image frames with a matrix multiplication, for example, as shown above in Equations 7-9.

The video decoder 500 can select a type of color space scaling to perform, such as independent channel prediction or one of the varieties of affine mixed channel prediction based on channel prediction parameters the video decoder 500 receives from the video encoder 300. In some embodiments, the video decoder 500 can perform a default or preset color space scaling of the decoded BT.709 image frames.

In some embodiments, the video decoder 500 can scale a resolution of the first residual frame from the first format into a resolution corresponding to the second format. For example, the UHDTV video standard can support a 4k (3840×2160 pixels) or an 8k (7680×4320 pixels) resolution and a 10 or 12 bit quantization bit-depth. The BT.709 video standard can support a 2k (1920×1080 pixels) resolution and an 8 or 10 bit quantization bit-depth. The video decoder 500 can scale the decoded first residual frame from a resolution corresponding to the BT.709 video standard into a resolution corresponding to the UHDTV video standard.

At a block 930, the video decoder 500 can generate a color space prediction based, at least in part, on the scaled color space of the first residual frame. The color space prediction can be a prediction of a UHDTV image frame (or portion thereof) from a color space of a corresponding decoded BT.709 image frame. In some embodiments, the video decoder 500 can generate the color space prediction based, at least in part, on the scaled resolution of the first residual frame.

At a block 940, the video decoder 500 can decode the encoded video stream into a second image having the second format based, at least in part, on the color space prediction. In some embodiments, the video decoder 500 can utilize the color space prediction to combine with a portion of the encoded video stream corresponding to a prediction residue from the video encoder 300. The combination of the color space prediction and the decoded prediction residue can correspond to a decoded UHDTV image frame or portion thereof.

Color bit depth scaling can provide enhancement of color coding and decoding in video compression, such as High Efficiency Video Coding (HEVC), a video coding standard currently under development and published in draft form, or other video compression systems. The bit depth scaling improves handling of differing color characteristics (e.g., resolution, quantization bit-depth, and color gamut) employed in different digital video formats, such as HD BT.709 and UHDTV BT.2020, for example, particularly during decoding. The following description is made with reference to HEVC, namely a publicly defined test model of a Scalable HEVC Extension, but is similarly applicable to other analogous video compression systems. For example, B. Bros, W-J. Han, J-R. Ohm, G. J. Sullivan, and T. Wiegand, “High efficiency video coding (HEVC) text specification draft 10,” JCTVC-L1003, Geneva, January 2013, describes an exemplary HEVC video system standard; G. Tech, K. Wegner, Y. Chen, M. Hannuksela, J. Boyce, “MV-HEVC Draft Text 5 (ISO/IEC 23008-2:201x/PDAM2),” JCT3V-E1004, Vienna, August 2013, describes a multi-view video system standard; for example, J. Chen, J. Boyce, Y. Ye, M. Hannuksela, “SHVC Draft 3,” JCTVC-N1008, Vienna, August 2013, describes a scalable-view video system standard; each of which is incorporated by reference herein in its entirety.

Encoders 300 and 301 of FIGS. 3A and 3B provide encoding of HD and UHDTV videos streams and each includes a color space predictor 400 that can generate a prediction of a UHDTV image frame (or picture) based on the upscaled resolution version of the reconstructed BT.709 image frame (or picture). As described above, the color space predictor 400 in some embodiments can scale a YUV color space of the upscaled resolution version of the reconstructed BT.709 image frame to correspond to the YUV representation supported by the UHDTV video stream 102.

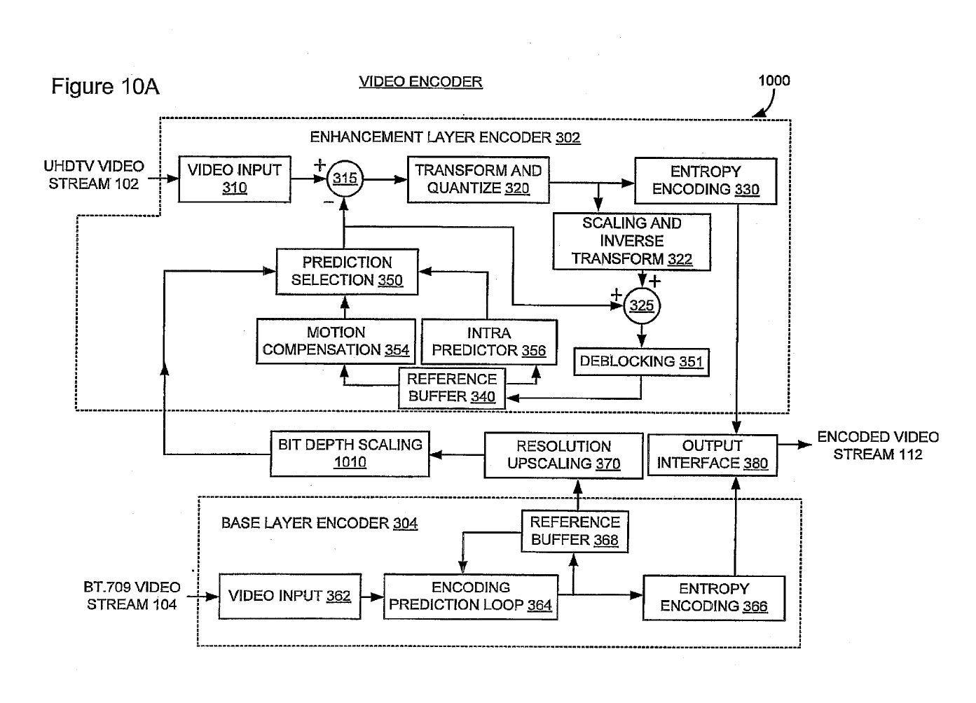

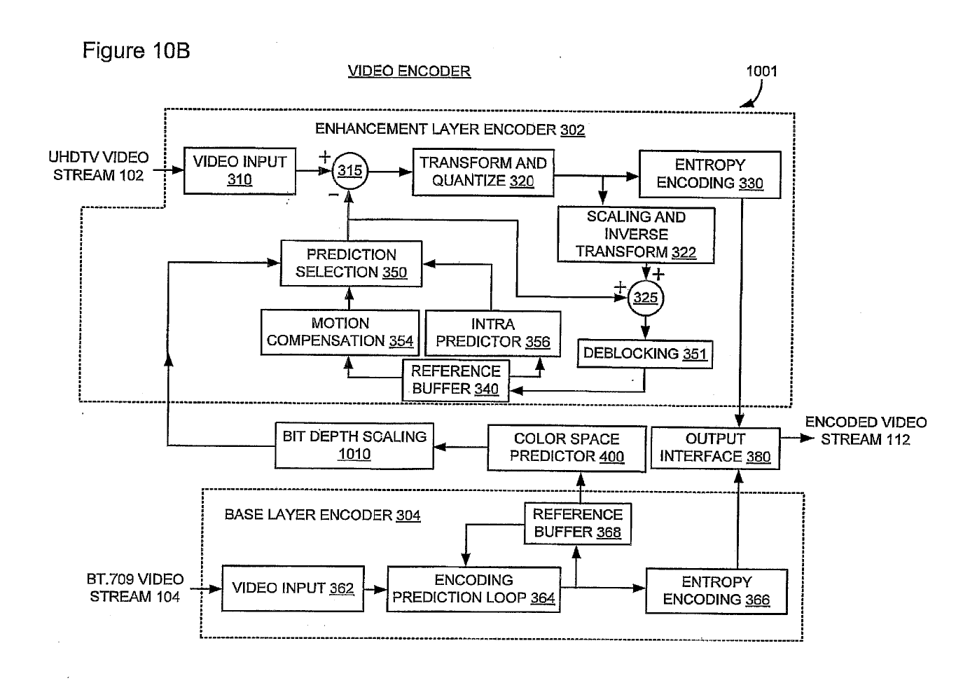

FIGS. 10A and 10B are block diagram examples of video encoders 1000 and 1001 that are analogous to encoders 300 and 301, respectively, and include corresponding elements indicated by the same reference numerals. In addition, encoders 1000 and 1001 each includes a bit depth scaling function 1010, rather than the color space predictor 400, to provide enhanced color bit depth scaling of frames or pictures, including bit depth scaling of reference pictures.

Video encoders 1000 and 1001 make reference to reference pictures (or frames), stored in reference buffers 340 and 368, in processing the pictures of a video stream.

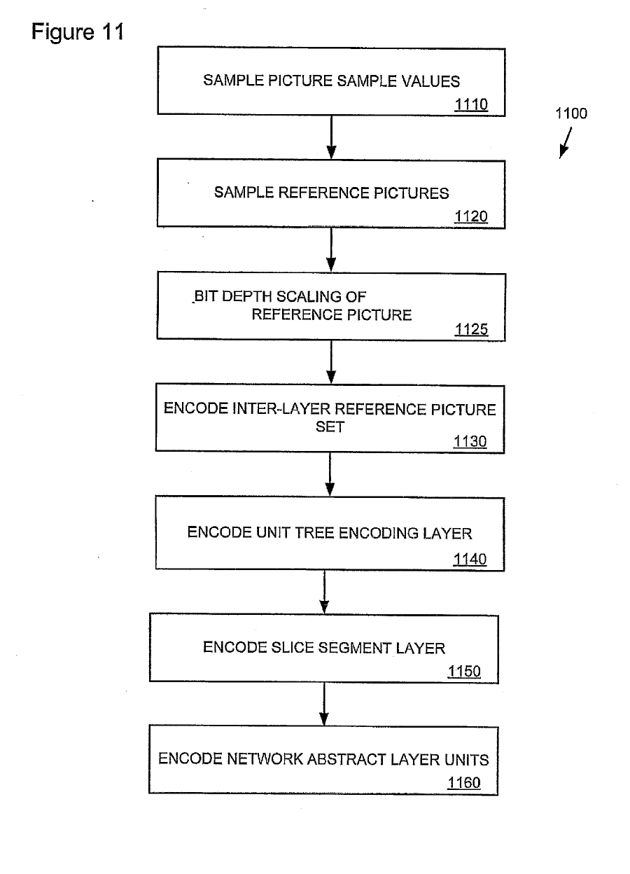

FIG. 11 is a simplified flow diagram of a video encoding method 1100 that includes bit depth scaling as performed by function 1010 and is described with reference to HEVC encoding.

With regard to a current picture CurrPic, step 1110 provides a sampling process for picture sample values using as inputs an array rsPicSampleL of luma samples, an array rsPicSampleCb of chroma samples of the component Cb, and an array rsPicSampleCr of chroma samples of the component Cr, and proving as outputs an array rlPicSampleL of luma samples, an array rlPicSampleCb of chroma samples of the component Cb, and an array rlPicSampleCr of chroma samples of the component Cr.

Step 1120 provides a sampling process for reference pictures to obtain a sampled inter-layer reference picture rsPic from a video picture input rsPic as input. Step 1120 may be invoked at the beginning of the encoding process for a first P or B slice of a current picture CurrPic.

Step 1125 provides a scaling of the bit depth of the inter-layer reference picture.

Step 1130 provides encoding of an inter-layer reference picture set to obtain a list of inter-layer pictures, which includes sampling bit depth scaled inter layer reference picture rsbPic. Step 1140 provides encoding of unit tree coding layers. Step 1150 provides encoding of slice segment layers, including encoding processes for each P or B slice and constructing reference picture list for each P or B slice. Step 1160 provides encoding of network abstraction layer (NAL) units, or packets.

Decoders 500 and 501 of FIGS. 5A and 5B provide decoding of encoded video streams that may correspond to HD and UHDTV videos streams. Decoders 500 and 501 and each includes a color space predictor 600 that can generate a prediction of UHDTV image frames (or pictures) based on BT.709 image frames decoded by the base layer decoder 504, as described above.

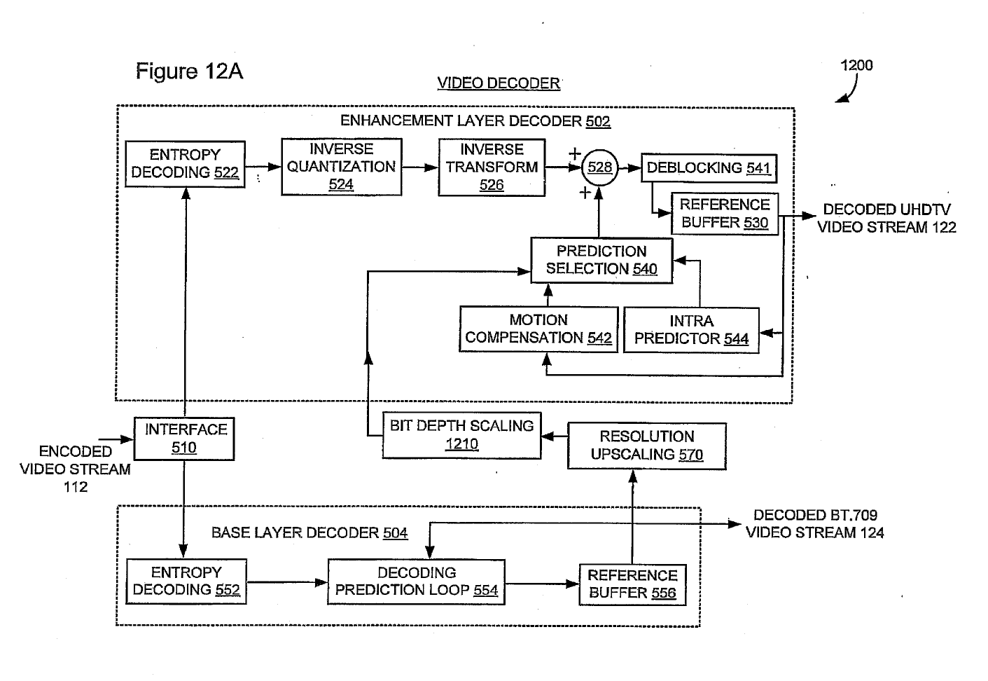

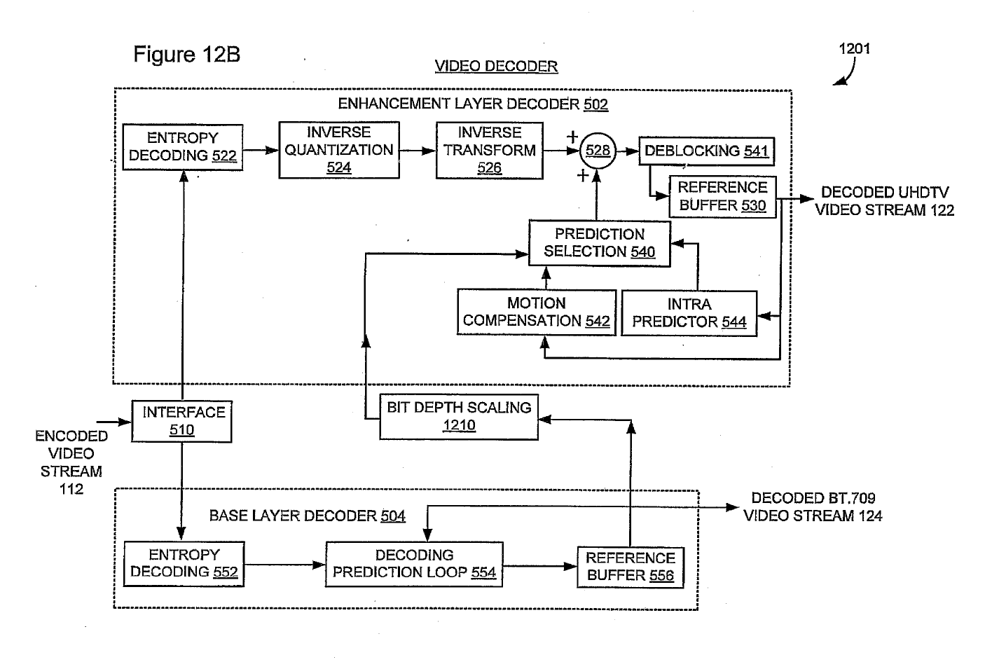

FIGS. 12A and 12B are block diagram examples of video decoders 1200 and 1201 that are analogous to decoders 500 and 501, respectively, and include corresponding elements indicated by the same reference numerals. In addition, decoders 1200 and 1201 each include a bit depth scaling function 1210, rather than the color space predictor 600 of decoders 500 and 501, to utilize the bit depth scaling of frames or pictures. Video decoders 1200 and 1201 provide decoding of encoded video streams, which include network abstraction layer units (or packets) with slices of coded pictures (or frames). The decoding obtains and utilizes reference pictures and inter-layer reference picture sets to obtain the picture sample values of the successive pictures of a video stream.

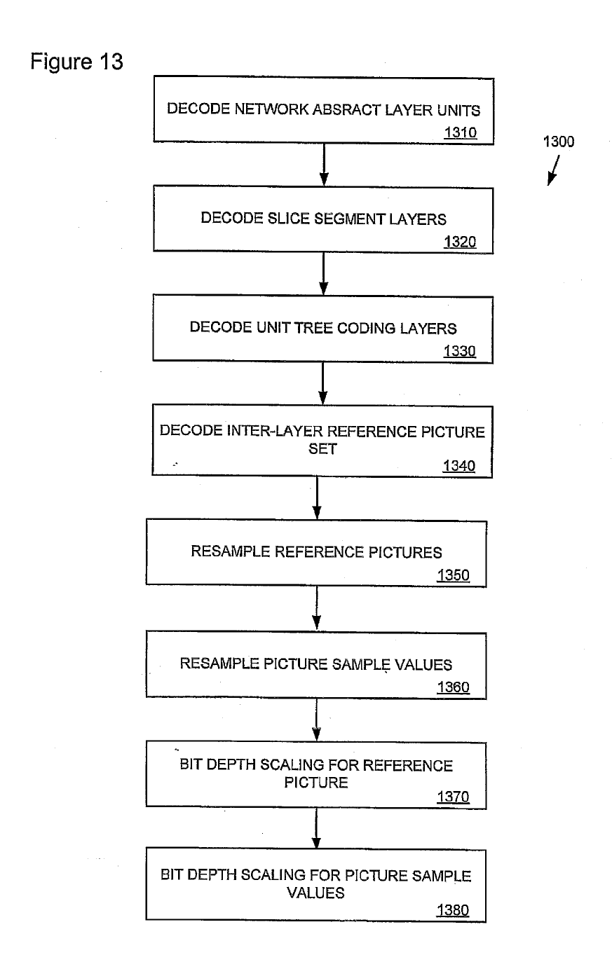

FIG. 13 is a flow diagram of one implementation of a decoding method 1300 that includes bit depth scaling processes as performed by function 1210 and is described with reference to HEVC decoding. With regard to a current picture CurrPic, step 1310 provides decoding of network abstraction layer (NAL) units, or packets. Step 1320 provides decoding with regard to slice segment layers, including decoding processes for each P or B slice and constructing a reference picture list for each P or B slice. Step 1330 provides decoding with regard to unit tree coding layers. Step 1340 provides decoding with regard to an inter-layer reference picture set to obtain a list of inter-layer pictures, which includes deriving a resampled bit depth scaled inter layer reference picture rsbPic.

Step 1350 provides a resampling process for reference pictures to obtain a resampled inter-layer reference picture rsPic from a decoded picture rsPic as input. Step 1350 may be invoked at the beginning of the decoding process for a first P or B slice of a current picture CurrPic. Step 1360 provides a resampling process for picture sample values using as inputs an array rlPicSampleL of luma samples, an array rlPicSampleCb of chroma samples of the component Cb, and an array rlPicSampleCr of chroma samples of the component Cr, and proving as outputs an array rsPicSampleL of luma samples, an array rsPicSampleCb of chroma samples of the component Cb, and an array rsPicSampleCr of chroma samples of the component Cr.

Steps 1310-1360 generally correspond to conventional HEVC decoding, except for the deriving a resampled bit depth scaled inter layer reference picture rsbPic in step 1340. The method 1300 includes a step 1370 that provides a bit depth scaling process for reference pictures and a step 1380 that provides a bit depth scaling process for picture sample values.

Bit depth scaling process for a reference picture of step 1370 operates on the resampled inter layer reference picture rsPic as an input and provides as an output a resampled bit depth scaled inter layer reference picture rsbPic. A benefit of resampled bit depth scaled inter layer reference picture rsbPic is that it accommodates forming inter-layer references from pictures at different bit-depths. Step 1370 uses variables nBdbY and nBdbC, which specify the bit depth of the samples of the luma array and bit depth of the samples of the chroma array of the current picture CurrPic, and variables nBdY and nBdC, which specify the bit depth of the samples of the luma array and bit depth of the samples of the chroma array of the resampled reference layer picture rsPic. Step 1370 derives a resampled bit depth scaled inter layer reference picture rsbPic with bit depth scaling as follows.
if nBdY is equal to nBdbY and nBdC is equal to nBdbC
   rsbPic is set to rsPic,
   otherwise rsPic is derived by follows:

The bit depth scaling of step 1380 is invoked with the resampled sample values of rsPicSample as input, and with the resampled bit depth scaled sample values of rsbPicSample as output. Bit depth scaling process for picture sample values of step 1380 operates on inputs:
(ScaledW)×(ScaledH) array rsPicSampleL of luma samples with bit depth nBdY,
(ScaledW/2)×(ScaledH/2) array rsPicSampleCb of chroma samples of the component Cb with bit depth nBdC, and
(ScaledW/2)×(ScaledH/2) array rsPicSampleCr of chroma samples of the component Cr with bit depth nBdC

and provides as outputs:
(ScaledW)×(ScaledH) array rsbPicSampleL of luma samples with bit depth nBdbYI,
(ScaledW/2)×(ScaledH/2) array rsbPicSampleCb of chroma samples of the component Cb with bit depth nBdbCI, and
(ScaledW/2)×(ScaledH/2) array rsbPicSampleCr of chroma samples of the component Cr with bit depth nBdbC.
   These output arrays correspond to reference pictures used for encoding the enhancement layer pictures. A benefit of bit-depth scaling of picture samples is accommodating prediction between pictures having samples that are at different bit-depths.

Bit depth scaling process for picture sample values of step 1380 operates as follows. For each luma sample location (xP=0 . . . ScaledW−1, yP=0 . . . ScaledH−1) in the luma sample array rsPicSampleL1, the corresponding luma sample value is derived as:

rsbPicSampleL[xP,yP]=rsPicSampleL[xP,yP]<<(nBdbY−nBdY).

For each chroma sample location (xP=0 . . . ScaledW/2−1, yP=0 . . . ScaledH/2−1) in the chroma sample array for the component Cb rsPicSampleCb, the corresponding chroma sample value is derived as

rsbPicSampleCb[xP,yP]=rsPicSampleCb[xP,yP]<<(nBdbC−nBdC)

For each chroma sample location (xP=0 . . . ScaledW/2−1, yP=0 . . . ScaledH/2−1) in the chroma sample array for the component Cr rsPicSampleCr, the corresponding chroma sample value is derived as:

rsbPicSampleCr[xP,yP]=rsPicSampleCr[xP,yP]<<(nBdbC−nBdC).

These equations compensate the reference picture for the sample bit-depth difference between the base and enhancement layers.

It will be appreciated that the bit depth scaling described above may be implemented in various alternative embodiments. For example, the bit depth variables used in steps 1370 and 1380 could be used to generate the color gamut scalable (CGS) enhancement layer. In one implementation, the bit depth scaling could require that motion compensation for the color gamut scalable (CGS) enhancement layer picture take place by using weighted prediction by utilizing uni-prediction as with the predictor being a base layer picture (e.g., re-sampled and bit depth scaled). A benefit of this implementation is that weighted prediction process defined in existing HEVC base specification could be utilized to perform color space prediction.

In another embodiment, whenever a layer i is a CGS enhancement layer, a direct_dependency_flag[i][i−1] could be set equal to 1 and a direct_dependency_flag[i][j] could be equal to 0 for j<i−1. This means that only a layer with index i−1 may be a direct reference layer for the layer with index i, thereby operating to constrain layer dependency signaling when using this color gamut scalable coding. A benefit of constraining layer dependency signaling is that reference picture list is simplified. As another alternative, whenever the layer i is a CGS enhancement layer, then:

$${\sum }_{j = 0}^{i = 1} direct\_dependency flag [ i ] [ j ] 1.$$

As a result, layer with index i may have only one direct reference layer from other layers. A benefit of constraining layer dependency signaling is that reference picture list is simplified.

In another implementation, the decoding process for each slice for the CGS enhancement layer picture can begin with deriving as follows a reference picture list RefPicList0 with regard to a variable NumRpsCurrTempList0, which refers to the number of entries in a temporary reference picture list—RefPicListTemp0—which is later used to create the list RefPicList0:
Set NumRpsCurrTempList0 equal to
Max(num_ref_idx_10_active_minus1+1, NumPocTotalCurr),

in which num_ref_idx_10_active_minus1+1 and NumPocTotalCurr are temporary variables, respectively, and then construct the list RefPicList0 as follows.
for(rIdx=0; rldx<=num_ref_idx_10_active_minus1; rldx++)
RefPicList0[rldx]=ref_pic_list_modification_flag_10?
RefPicSetInterLayer [list_entry_10[rldx]]: RefPicSetInterLayer [rldx]

It could also be a requirement that when the layer i is a CGS enhancement layer, num_ref_idx_IO_active_minus1 may be equal to 0.

Video compression systems such as HEVC, and the predecessor video compression standard H.264/MPEG-4 AVC, employ a video parameter set (VPS) structure in which video parameter sets, including extensions of video parameter sets, contain information that can be used to decode several regions of encoded video. For example, current HEVC includes a syntax for extending video parameter sets under vps_extension( ) as set forth in Table 3:

TABLE 3

Descriptor

vps_extension( ) {

while( !byte_aligned( ) )

| | |
|---|---|
| vps_extension_byte_alignment_reserved_one_bit u(1) | (u)1 |

ave_ base _layer_flag u( I )
splitting_ flag u(I )
for( i = 0, NumScalabilityTypes = 0; i < 16; i++) {

scalability_mask[ i] u(1)
NumScalabilityTypes += scalability_mask[ i]

}
for( j = 0; j <NumScalabilityTypes; j++ )

dimension- id_ len_minus1 [ j]

...
for( i = 1; i <= vps_max_layers_minus1; i++ ) {

for( j = 0; j < i; j++ )
direct_dependency_flag[ i ][ j]

}

Conventional video parameter sets under vps_extension( ) in HEVC, as set forth in Table 3, provide only limited characterization of color characteristics of an encoded video format. In contrast, an expanded vps_extension( ) set forth in Table 4 includes specific attributes regarding the color characteristics of an encoded video format, thereby signaling color gamut scalability and bit depth information regarding enhancement layers in the vps extension. The information about bit depth of luma and chroma components of each layer and about chromaticity coordinates of the source primaries of each layer can be useful for session negotiation in allowing end devices to select layers to decode based on their bit depth and color support capability.

TABLE 4

Descriptor

vps_extension( ) {

while( !byte_aligned( ) )

| | |
|---|---|
| vps_extension_byte_alignment_reserved_one_bit | u(1) |

| | |
|---|---|
| ave_ base _layer_flag | u(1) |
| splitting_ flag u(l ) | u(1) |
| for( i = 0, NumScalabilityTypes = 0; i < 16; i++) { | |

| | |
|---|---|
| scalability_mask[ i] | u(1) |
| NumScalabilityTypes += scalability_mask[ i] | |

}
for( j = 0; j <NumScalabilityTypes; j++ )

| | |
|---|---|
| dimension- id_ len_minus1 [ j] | u(1) |

...
for( i = 1; i <= vps_max_layers_minus1; i++ ) {

| | |
|---|---|
| for( j = 0; j < i; j++ ) | |
| direct_dependency_flag[ i ][ j] | u(1) |

}
for( i = 1; i <= vps_max_layers~m i nus1; i++ ) {

bitdepth_colorgamut_info(i)

}
bitdepth_colorgamut_info(id){

| | |
|---|---|
| bit depth layer luma minus8[id] | ue(v) |
| bit depth layer chroma minus8[id] | ue(v) |
| layer color _gamut[id] | u(1) |

}

The an expanded vps_extension( ) set includes the attributes:

‘bit_depth_layer_luma_minus8[id]+8’ which may specify the bit depth of the samples of the luminance (sometimes referred to as “luma”) array for the layer with layer id id, as specified by:

BitDepthLy[id]=8+bit_depth_layer_luma_minus8[id],

with bit_depth_layer_luma_minus8 in the range of 0 to 6, inclusive, according to or indicating the bit-depth of the luma component of the video in the range 8 to 14.

‘bit_depth_layer_chroma_minus8[id]+8’ which may specify the bit depth of the samples of the chrominance (sometimes referred to as “chroma”) arrays for the layer with layer id id, as specified by:

BitDepthLc[id]=8+bit_depth_layer_chroma_minus8[id],

with bit_depth_layer_chroma_minus8 in the range of 0 to 6, inclusive, according to or indicating the bit-depth of the chroma components of the video in the range 8 to 14. ‘layer_color_gamut[id]’ is set equal to 1 to specify that the chromaticity coordinates of the source primaries for layer id are defined as per Rec. ITU-R BT.2020, and layer_color_gamut[id] is set equal to 0 to specify that the chromaticity coordinates of the source primaries for layer id are defined as per Rec. ITU-R BT.709.

In an alternative embodiment, separate bit depth may be signaled for chroma components Cb and Cr. In another alternative embodiment, the bitdepth_colorgamut_info( ) could also be signaled for the base layer. In this case the for loop index in the vps_extension can start from i=0 instead of i=1. In still another alternative embodiment, color primaries other than BT.709 and BT.2020 may be indicated such as, for example, by a syntax element similar to colour_primaries syntax element signalled in video usability information (VUI) of HEVC draft specification could be signaled for each layer to indicate its color primary.

Picture parameter sets (“PPS”) carry data valid on a picture by picture basis. Accordingly, the PPS is a syntax structure containing syntax elements that apply to zero or more entire coded pictures as determined by a syntax element, such as that found in each slice segment header.

Sequence parameter sets (“SPS”) may be used to carry data valid for an entire video sequence. Accordingly, the SPS is a syntax structure containing syntax elements that apply to zero or more entire coded video sequences (“CVS”) as determined by the content of a syntax element found in the PPS referred to by a syntax element, such as that found in each slice segment header.

Video parameter sets (“VPS”) may be used to carry data valid for an entire video sequence. Accordingly, the VPS is a syntax structure containing syntax elements that apply to zero or more entire coded video sequences as determined by the content of a syntax element found in the SPS referred to by a syntax element found in the PPS referred to by a syntax element found in each slice segment header.

A modified syntax for video parameter set extension (vps_extension( )) which is signaled inside a video parameter set VPS is shown in Table 5.

TABLE 5

Descriptor

vps_extension( ) {

| | |
|---|---|
| ... | |
| vps_num_rep_formats_minus1 | u(4) |
| for( i = 0; i <= vps_num_rep_formats_minus1; i++ ) | |

rep_format( )

for( i = 1; i <= vps_max_layers_minus1; i++ )

if( vps_num_rep_formats_minus1> 0)

| | |
|---|---|
| vps_rep_format_idx[ i ] | u(4) |

| | |
|---|---|
| max_one_active_ref_layer_flag | u(1) |
| ... | |

}

max_one_active_ref_layer_flag is signaled in VPS extension. max_one_active_ref_layer_flag equal to 1 may specify that at most one picture is used for inter-layer prediction for each picture in the CVS. max_one_active_ref_layer_flag equal to 0 may specify that more than one picture may be used for inter-layer prediction for each picture in the CVS.

nuh_layer_id may specify the identifier of the layer.

Vps_max_layers_minus1 plus 1 may specify the maximum number of layers that may be present in the CVS, wherein a layer may e.g. be a spatial scalable layer, a quality scalable layer, a texture view or a depth view.

layer_id_in_nuh[i] may specify the value of the nuh_layer_id syntax element in VCL NAL units of the i-th layer. For i in a range from 0 to vps_max_layers_minus1, inclusive, when not present, the value of layer_id_in_nuh[i] may be inferred to be equal to i. When i is greater than 0, layer_id_in_nuh[i] may be greater than layer_id_in_nuh[i−1]. For i in a range from 0 to vps_max_layers_minus1, inclusive, the variable LayerIdxInVps[layer_id_in_nuh[i] ] may be set equal to i.

vps_num_rep_formats_minus1 plus 1 may specify the number of the following rep_format( ) syntax structures in the VPS. The first report format syntax structure rep_format( ) with i=0 provides information applicable to layer with nuh_layer_id equal to 0. It is a requirement of bitstream conformance that the values of rep_format( ) for i=0 for chroma_format_vps_idc, separate_colour_plane_vps_flag, pic_width_vps_in_luma_samples, pic_height_vps_in_luma_samples, bit_depth_vps_luma_minus8, or bit_depth_vps_chroma_minus8 may not be less than respectively, chroma_format_idc, separate_colour_plane_flag, pic_width_in_luma_samples, pic_height_in_luma_samples, bit_depth_luma_minus8, or bit_depth_chroma_minus8 syntax elements in any SPS in the CVS with nuh_layer_id equal to 0.

In some embodiments the term representation format may be used to include syntax elements chroma_format_idc, separate_colour_plane_flag, pic_width_in_luma_samples, pic_height_in_luma_samples, bit_depth_luma_minus8, or bit_depth_chroma_minus8 in SPS and/or syntax elements chroma_format_vps_idc, separate_colour_plane_vps_flag, pic_width_vps_in_luma_samples, pic_height_vps_in_luma_samples, bit_depth_vps_luma_minus8, or bit_depth_vps_chroma_minus8 in VPS. In some embodiments the representation format information may be called source format information.

In some embodiments it may be required that the first representation format information including bit-depth of luma samples, bit depth of chroma samples and color chromaticity information be sent corresponding to the format of layer with nuh_layer_id equal to 0. In some case the layer with nuh_layer_id equal to 0 may be a base layer. In some embodiments source format information sent in first representation format may provides a meaningful upper bound to corresponding source information SPS syntax elements values for active SPS with nuh_layer_id equal to 0.

vps_rep_format_idx[i] may specify the index, into the list of rep_format( ) syntax structures in the VPS, of the rep_format( ) syntax structure that applies to the layer with nuh_layer_id equal to layer_id_in_nuh[i]. When i is equal to 0 or vps_num_rep_formats_minus1 is equal to 0, the value of vps_rep_format_idx[i] is inferred to be equal to 0. The value of vps_rep_format_idx[i] may be in the range of 0 to vps_num_rep_formats−1, inclusive.

A syntax structure for rep_format( ) is shown in Table 6.

TABLE 6

Descriptor

rep_format( ) {

| | |
|---|---|
| chroma_format_vps_idc | u(2) |
| if( chroma_format_vps_idc = = 3 ) | |

| | |
|---|---|
| separate_colour_plane_vps_flag | u(1) |

| | |
|---|---|
| pic_width_vps_in_luma_samples | u(16) |
| pic_height_vps_in_luma_samples | u(16) |
| bit_depth_vps_luma_minus8 | u(3) |
| bit_depth_vps_chroma_minus8 | u(3) |
| layer_color_gamut | u(1) |

}

chroma_format_vps_idc, separate_colour_plane_vps_flag, pic_width_vps_in_luma_samples, pic_height_vps_in_luma_samples, bit_depth_vps_luma_minus8, and bit_depth_vps_chroma_minus8 are used for inference of the values of the SPS syntax elements chroma_format_idc, separate_colour_plane_flag, pic_width_in_luma_samples, pic_height_in_luma_samples, bit_depth_luma_minus8, and bit_depth_chroma_minus8, respectively, for each SPS that refers to the VPS.

For each of these syntax elements, all constraints, if any, that apply to the value of the corresponding SPS syntax element also apply.

layer_color_gamut equal to 1 may specify that the chromaticity coordinates of the source primaries are defined as per Rec. ITU-R BT.2020. layer_color_gamut[id] equal to 0 may specify that the chromaticity coordinates of the source primaries are defined as per Rec. ITU-R BT.709.

A syntax structure for a sequence parameter set (SPS) is shown in Table 7 below.

TABLE 7

```
seq_parameter_set_rbsp( ) {
  sps_video_parameter_set_id
  if( nuh_layer_id = = 0 ) {
    sps_max_sub_layers_minus1
    sps_temporal_id_nesting_flag
    profile_tier_level( 1, sps_max_sub_layers_minus1 )
  }
  sps_seq_parameter_set_id
  if( nuh_layer_id > 0 )
    update_rep_format_flag
  if( update_rep_format_flag ) {
    chroma_format_idc
    if( chroma_format_idc = = 3 )
      separate_colour_plane_flag
    pic_width_in_luma_samples
    pic_height_in_luma_samples
  }
  ...
  if( update_rep_format_flag ) {
    bit_depth_luma_minus8
    bit_depth_chroma_minus8
  }
  ...
}
```

sps_video_parameter_set_id may specify the value of the vps_video_parameter_set_id of the active VPS. vps_video_parameter_set_id identifies the VPS for reference by other syntax elements.

sps_max_sub_layers_minus1 plus 1 may specify the maximum number of temporal sub-layers that may be present in each CVS referring to the SPS. The value of sps_max_sub_layers_minus1 may be in the range of 0 to 6, inclusive. A temporal sublayer is a temporal scalable layer of a temporal scalable bitstream, consisting of video coding layer network abstraction (VCL NAL) units with a particular value of temporal identifier and the associated non-VCL NAL units.

sps_temporal_id_nesting_flag, when sps_max_sub_layers_minus1 is greater than 0, may specify whether inter prediction is additionally restricted for CVSs referring to the SPS. When sps_max_sub_layers_minus1 is equal to 0, sps_temporal_id_nesting_flag may be equal to 1.

The syntax element sps_temporal_id_nesting_flag may be used to indicate that temporal up-switching, i.e. switching from decoding up to any TemporalId tIdN to decoding up to any TemporalId tIdM that is greater than tIdN, is always possible in the CVS.

sps_seq_parameter_set_id provides an identifier for the SPS for reference by other syntax elements. The value of sps_seq_parameter_set_id may be in the range of 0 to 15, inclusive.

chroma_format_idc may specify the chroma sampling relative to the luma sampling. The value of chroma_format_idc may be in the range of 0 to 3, inclusive.

separate_colour_plane_flag equal to 1 may specify that the three colour components of the 4:4:4 chroma format are coded separately. separate_colour_plane_flag equal to 0 may specify that the colour components are not coded separately. When separate_colour_plane_flag is not present, it may be inferred to be equal to 0. When separate_colour_plane_flag is equal to 1, the coded picture may consist of three separate components, each of which may consist of coded samples of one colour plane (Y, Cb, or Cr) and may use the monochrome coding syntax. In this case, each colour plane may be associated with a specific colour_plane_id value.

Depending on the value of separate_colour_plane_flag, the value of the variable ChromaArrayType may be assigned as follows:

If separate_colour_plane_flag is equal to 0, ChromaArrayType may be set equal to chroma_format_idc.

Otherwise (separate_colour_plane_flag is equal to 1), ChromaArrayType may be set equal to 0.

pic_width_in_luma_samples may specify the width of each decoded picture in units of luma samples. pic_width_in_luma_samples may not be equal to 0 and may be an integer multiple of a variable MinCbSizeY.

pic_height_in_luma_samples may specify the height of each decoded picture in units of luma samples. pic_height_in_luma_samples may not be equal to 0 and may be an integer

bit_depth_luma_minus8 may specify the bit depth of the samples of the luma array BitDepthY and the value of the luma quantization parameter range offset QpBdOffsetY as follows:

BitDepthY=8+bit_depth_luma_minus8

QpBdOffsetY=6*bit_depth_luma_minus8

bit_depth_luma_minus8 may be in the range of 0 to 6, inclusive. bit_depth_chroma_minus8 may specify the bit depth of the samples of the chroma arrays BitDepthC and the value of the chroma quantization parameter range offset QpBdOffsetC as follows:

BitDepthC=8+bit_depth_chroma_minus8

QpBdOffsetC=6*bitdepth_chroma_minus8
bit_depth_chroma_minus8 may be in the range of 0 to 6, inclusive.

update_rep_format_flag equal to 1 may specify that the syntax elements chroma_format_idc, separate_colour_plane_flag, pic_width_in_luma_samples, pic_height_in_luma_samples, bit_depth_luma_minus8, and bit_depth_chroma_minus8 are explicitly signalled in the SPS and all the layers with nuh_layer_id greater than zero that refer to this SPS use these values instead of those signalled in the VPS when the nuh_layer_id of the SPS is greater than 0. update_rep_format_flag equal to 0 may specify that the syntax elements chroma_format_idc, separate_colour_plane_flag, pic_width_in_luma_samples, pic_height_in_luma_samples, bit_depth_luma_minus8, and bit_depth_chroma_minus8 are not signalled in the SPS and all the layers that refer to this SPS use the values signaled in the VPS. When not present, the value of update_rep_format_flag is inferred to be equal to 1. Thus for a base layer or a layer with nuh_layer_id equal to 0 update_rep_format_flag may be inferred to be equal to 1 and the syntax elements chroma_format_idc, separate_colour_plane_flag, pic_width_in_luma_samples, pic_height_in_luma_samples, bit_depth_luma_minus8, and bit_depth_chroma_minus8 are explicitly signalled in this SPS with nuh_layer_id equal to 0.

When a current picture with nuh_layer_id layerIdCurr greater than 0 refers to an SPS, the values of chroma_format_idc, separate_colour_plane_flag, pic_width_in_luma_samples, pic_height_in_luma_samples, bit_depth_luma_minus8, and bit_depth_chroma_minus8 may be inferred or constrained as follows:
If the nuh_layer_id of the active layer SPS is equal to 0,
   Then if vps_rep_format_idx[j] in the active VPS where j is equal to LayerIdxInVps[layerIdCurr] is equal to 0 the values of chroma_format_idc, separate_colour_plane_flag, pic_width_in_luma_samples, pic_height_in_luma_samples, bit_depth_luma_minus8, and bit_depth_chroma_minus8 may be inferred to be equal to the respective values from the active layer SPS.
   Then if vps_rep_format_idx[j] in the active VPS where j is equal to LayerIdxInVps[layerIdCurr] is not equal to 0 the values of chroma_format_idc, separate_colour_plane_flag, pic_width_in_luma_samples, pic_height_in_luma_samples, bit_depth_luma_minus8, and bit_depth_chroma_minus8 may be inferred to be equal to chroma_format_vps_idc, separate_colour_plane_vps_flag, pic_width_vps_in_luma_samples, pic_height_vps_in_luma_samples, bit_depth_vps_luma_minus8, and bit_depth_vps_chroma_minus8, respectively, of the vps_rep_format_idx[j]-th rep_format( )) syntax structure in the active VPS where j is equal to LayerIdxInVps[layerIdCurr] and the values of chroma_format_idc, separate_colour_plane_flag, pic_width_in_luma_samples, pic_height_in_luma_samples, bit_depth_luma_minus8, and bit_depth_chroma_minus8 of the active layer SPS may be ignored. Otherwise when the nuh_layer_id of the active layer SPS is greater than zero, the following may b e used for inference of various values:
   If update_rep_format_flag is equal to 0, the values of chroma_format_idc, separate_colour_plane_flag, pic_width_in_luma_samples, pic_height_in_luma_samples, bit_depth_luma_minus8, and bit_depth_chroma_minus8 may be inferred to be equal to chroma_format_vps_idc, separate_colour_plane_vps_flag, pic_width_vps_in_luma_samples, pic_height_vps_in_luma_samples, bit_depth_vps_luma_minus8, and bit_depth_vps_chroma_minus8, respectively, of the vps_rep_format_idx[j]-th rep_format( ) syntax structure in the active VPS, where j is equal to LayerIdxInVps[layerIdCurr].
   Otherwise (update_rep_format_flag is equal to 1), it may be a requirement of bitstream conformance that the value of chroma_format_idc, separate_colour_plane_flag, pic_width_in_luma_samples, pic_height_in_luma_samples, bit_depth_luma_minus8, or bit_depth_chroma_minus8 may be less than or equal to chroma_format_vps_idc, separate_colour_plane_vps_flag, pic_width_vps_in_luma_samples, pic_height_vps_in_luma_samples, bit_depth_vps_luma_minus8, or bit_depth_vps_chroma_minus8, respectively, of the vps_rep_format_idx[j]-th rep_format( )) syntax structure in the active VPS, where j is equal to LayerIdxInVps[layerIdCurr].

In some embodiments parameter update inference when SPS carries representation format information may allow updating the representation format information for higher layers from a SPS of base layer. In some embodiment higher layers may be layers with nuh_layer_id greater than zero. In some embodiments base layer may be layer with nuh_layer_equal to 0. Thus in some embodiments parameter update inference when SPS carries representation format information may allow updating the representation format information for layers with nuh_layer_id greater than zero from a SPS of layer with nuh_layer_id equal to 0. The SPS with nuh_layer_id equal to zero may be the active SPS for the layers with nuh_layer_id greater than or equal to 0.

A few more embodiments for signaling rep_format( ) and related syntax elements are described next. These are further variants of the Table 5.

A modified syntax for video_parameter set extension (vps_extension( )) which is signaled inside a video_parameter set VPS is shown in Table 8. This is a variant of the syntax in Table 5.

TABLE 8

Descriptor

vps_extension( ) {

...

| rep_format_idx_present_flag | | u(1) |
|---|---|---|
| if(rep_format_idx_present_flag) | | |
| | vps_num_rep_formats_minus1 | u(4) |

for( i = 0; i <= vps_num_rep_formats_minus1; i++ )

rep_format( )

if(rep_format_idx_present_flag) {

for( i = 1; i <= vps_max_layers_minus1; i++ )

if( vps_num_rep_formats_minus1> 0)

| | |
|---|---|
| vps_rep_format_idx[ i ] | u(4) |

}

| | |
|---|---|
| max_one_active_ref_layer_flag | u(1) |
| ... | |

}

rep_format_idx_present_flag equal to 1 indicates that the syntax elements vps_num_rep_formats_minus1 and vps_rep_format_idx[i] may be present. rep_format_idx_present_flag equal to 0 indicates that the syntax elements vps_num_rep_formats_minus1 and vps_rep_format_idx[i] are not present. In this case vps_num_rep_formats_minus1 is inferred to be equal to vps_max_layers_minus1 and vps_rep_format_idx[i] is inferred to be equal to i for each of i=0, . . . , vps_max_layers_minus1.

Other syntax elements may have the same semantics meanings as in Table 5.

Two modified syntax for video_parameter set extension (vps_extension( )) which is signaled inside a video_parameter set VPS are shown in Table 9A and Table 9B. These is a variant of the syntax in Table 5.

TABLE 9A

Descriptor

vps_extension( ) {

...

| | |
|---|---|
| vps_num_rep_formats | u(4) |

for( i = 0; i < vps_num_rep_formats; i++ )

rep_format( )

for( i = 1; i <= vps_max_layers_minus1; i++ )

if( vps_num_rep_formats > 1)

| | |
|---|---|
| vps_rep_format_idx[ i ] | u(4) |

| | |
|---|---|
| max_one_active_ref_layer_flag | u(1) |
| ... | |

}

TABLE 9B

Descriptor

vps_extension( ) {

...

| rep_format_idx_present_flag | | u(1) |
|---|---|---|
| if(rep_format_idx_present_flag) | | |
| | vps_num_rep_formats | u(4) |

for( i = 0; i < vps_num_rep_formats; i++ )

rep_format( )

if(rep_format_idx_present_flag) {

for( i = 1; i <= vps_max_layers_minus1; i++ )

if( vps_num_rep_formats > 1)

| | |
|---|---|
| vps_rep_format_idx[ i ] | u(4) |

}

| | |
|---|---|
| max_one_active_ref_layer_flag | u(1) |
| ... | |

}

vps_num_rep_formats specifies the number of the following rep_format( ) syntax structures in the VPS. If vps_num_rep_formats is equal to 0 then no representation format information is signaled in VPS. In this case rep_format_idx_present_flag may be set to 1.
Other syntax elements may have the same semantics meanings as in Table 5. A modified syntax for video parameter set extension (vps_extension( )) which is signaled inside a video parameter set VPS is shown in Table 10. This is a variant of the syntax in Table 5.

TABLE 10

Descriptor

vps_extension( ) {

| | ... | |
|---|---|---|
| vps_rep_format_information_present_flag | | u(1) |
| If(vps_rep_format_information_present_flag) { | | |
| | vps_num_rep_formats_minus1 | u(4) |
| | for( i = 0; i <= vps_num_rep_formats_minus1; i++ ) | |

rep_format( )

for( i = 1; i <= vps_max_layers_minus1; i++ )

if( vps_num_rep_formats_minus1> 0)

| | |
|---|---|
| vps_rep_format_idx[ i ] | u(4) |

}

| | |
|---|---|
| max_one_active_ref_layer_flag | u(1) |
| ... | |

}

vps_rep_format_information_present_flag equal to 1 indicates that the syntax elements vps_num_rep_formats_minus1 and vps_rep_format_idx[i] may be present. vps_rep_format_information_present_flag equal to 0 indicates that the syntax elements vps_num_rep_formats_minus1 and vps_rep_format_idx[i] are not present.

Other syntax elements may have the same semantics meanings as in Table 5.

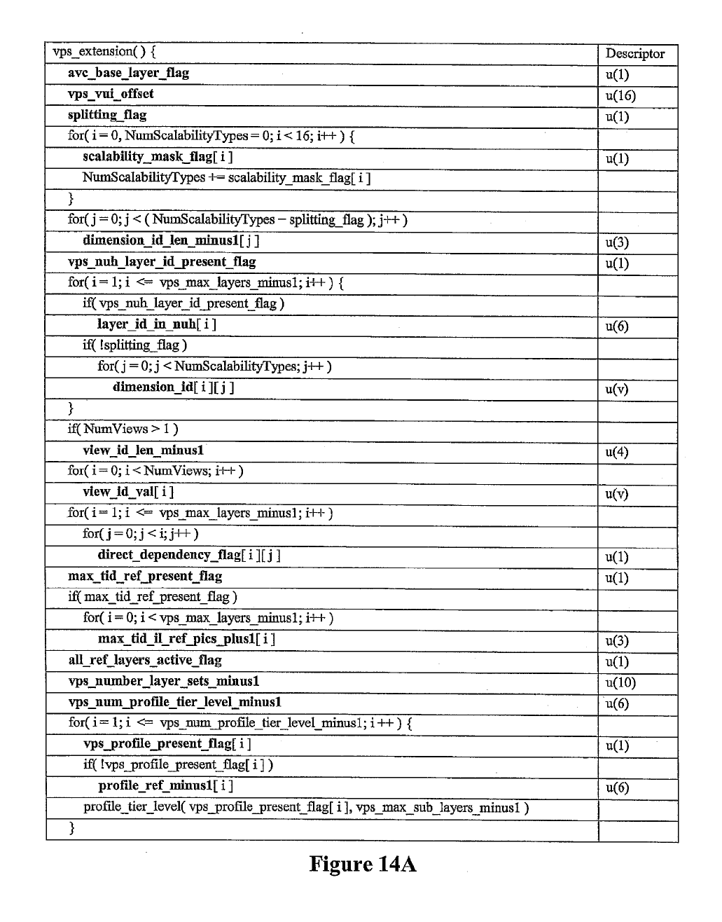

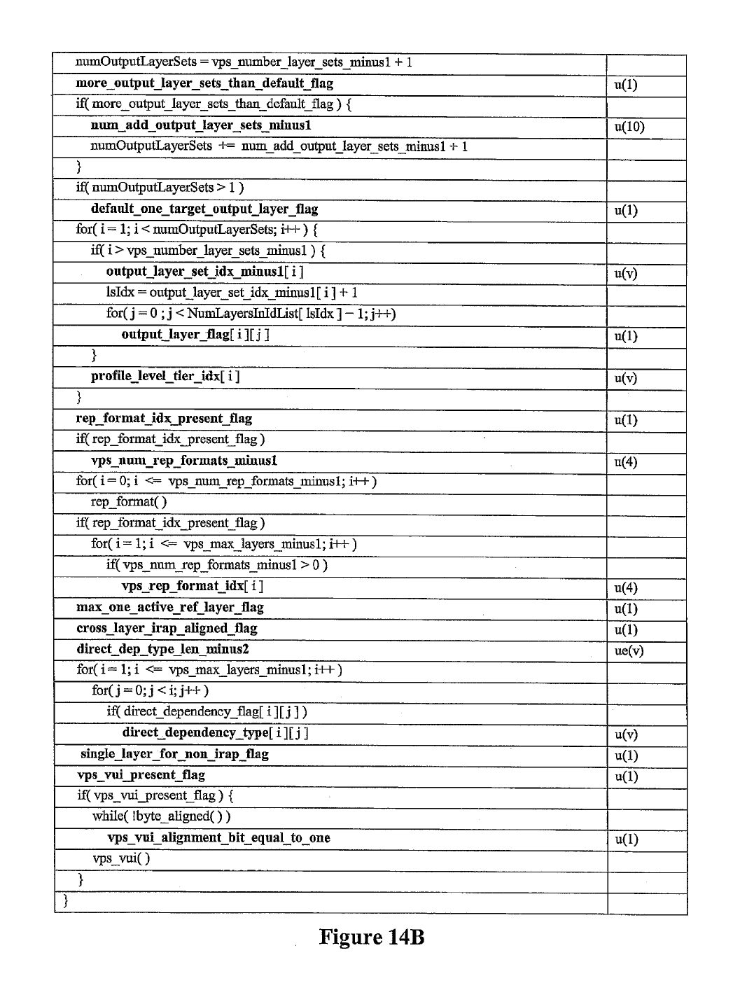

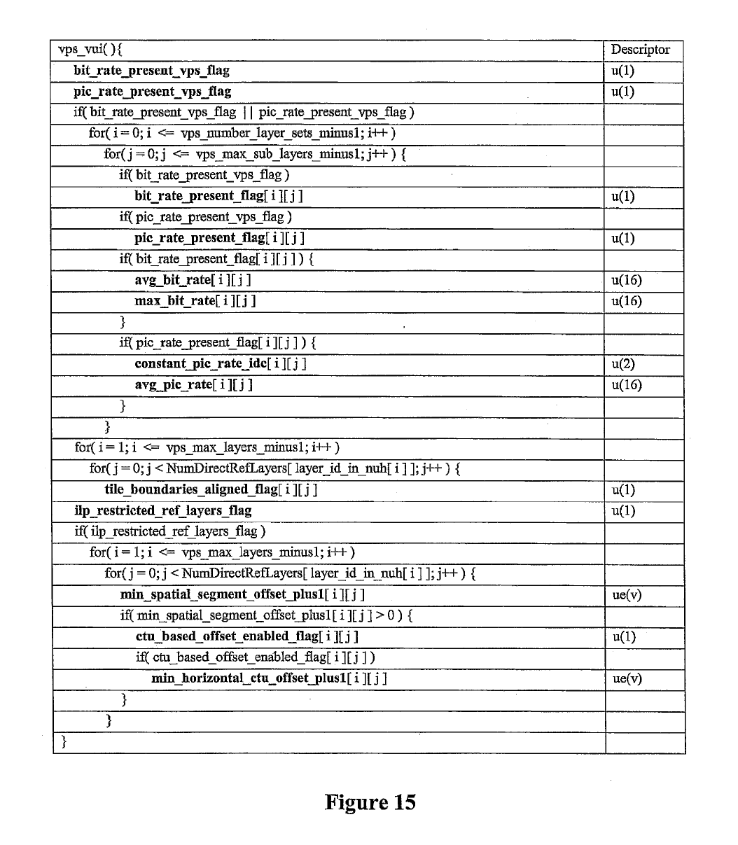

Referring to FIG. 14A and FIG. 14B, an exemplary vps_extension( ) syntax which is part of a sequence parameter set is illustrated as included in J. Chen, J. Boyce, Y. Ye, M. Hannuksela, “SHVC Draft 3”, JCTVC-N1008, Version 1, Vienna, August 2013, incorporated by reference herein. Referring to FIG. 15, an exemplary vps_vui( ) syntax which is referenced by a vps_extension( ) which is part of a sequence parameter set is illustrated as included in J. Chen, J. Boyce, Y. Ye, M. Hannuksela, “SHVC Draft 3”, JCTVC-N1008, Version 1, Vienna, August 2013, incorporated by reference herein. An additional syntax structure, may be included in any suitable location within the syntax structures, and preferably within the vps_extension( ) syntax or vps_vui( ) syntax, that includes suitable information related to color information and chromaticity information, and techniques for the sharing of such information thereof among other syntax structures.

It is desirable to select the layers to decode based upon knowledge regarding color chromaticity and other color information about the layers in a scalable bitstream which may further be based upon the client device capability. A modified technique useful for session negotiation preferably signals such information in the VPS.

By way of example, UHDTV devices and content may use a different color gamut than legacy devices. High definition devices may use the ITU-R BT.709 recommendation while UHDTV devices may use the ITU-R BT.2020 recommendation. The color gamut of UHDTV is significantly larger than HD. Also, consumer applications using BT.709 may have an 8-bit sample bit depth while BT.2020 only defines 10-bit and 12-bit sample bit depths. Accordingly, a suitable signaling of the color chromaticity and other color information in the VPS enables the determination of UHDTV layers which are using ITU-R BT.2020 during session negotiation.

A modified vps_extension( ) syntax may be as illustrated in Table 11.

TABLE 11

Descriptor

vps_extension( ) {

| | |
|---|---|
| ... | |
| video_signal_info_idx_present_flag | u(1) |
| if( video_signal_info_idx_present_flag ) | |

| | |
|---|---|
| vps_num_video_signal_info_minus1 | u(4) |

for( i = 0; i <= vps_num_video_signal_info_minus1; i++ )

video_signal_info( )

if( video_signal_info_idx_present_flag ) {

for( i = 1; i <= vps_max_layers_minus1; i++ )

if( vps_num_video_signal_info_minus1 > 0)

| | |
|---|---|
| vps_video_signal_info_idx[ i ] | u(4) |

}
...

}

### Table 11

In another embodiment the modified vps_extension( ) syntax may be signaled inside vps_vui( ) section of the VPS extension as illustrated in Table 11A.

TABLE 11A

Descriptor

vps_vui( ) {

| | |
|---|---|
| ... | |
| video_signal_info_idx_present_flag | u(1) |
| if( video_signal_info_idx_present_flag ) | |

| | |
|---|---|
| vps_num_video_signal_info_minus1 | u(4) |

for( i = 0; i <= vps_num_video_signal_info_minus1; i++ )

video_signal_info( )

if( video_signal_info_idx_present_flag ) {

for( i = 1; i <= vps_max_layers_minus1; i++ )

if( vps_num_video_signal_info_minus1 > 0)

| | |
|---|---|
| vps_video_signal_info_idx[ i ] | u(4) |

}
...

}

The video_signal_info_idx_present_flag equal to 1 indicates that the syntax elements vps_num_video_signal_info_minus1, video_signal_info( ) and vps_video_signal_info_idx[i] are present. The video_signal_info_idx_present_flag equal to 0 indicates that the syntax elements vps_num_video_signal_info_minus1, video_signal_info( ) and vps_video_signal_info_idx[i] are not present. When video_signal_info_idx_present_flag is equal to 0 vps_num_video_signal_info_minus1 is inferred to be equal to vps_max_layers_minus1 and vps_video_signal_info_idx[i] is inferred to be equal to i for each of i=0, . . . , vps_max_layers_minus1.

The vps_num_video_signal_info_minus1 plus 1 specifies the number of the following video_signal_info( )) syntax structures in the VPS. When not present, the value of vps_num_video_signal_info_minus1 is inferred to be equal to vps_max_layers_minus1.
It may be a requirement of bitstream conformance that the value of video_vps_format, video_full_range_vps_flag, colour_primaries_vps, transfer_characteristics_vps, and matrix_coeffs_vps in the 0-th video_signal_info( ) are not lower in terms of capability than the value of video_format, video_full_range_flag, colour_primaries, transfer_characteristics, and matrix_coeffs, respectively present in any active SPS that has nuh_layer_id equal to zero and that refers to this VPS.
The vps_video_signal_info_idx[i] specifies the index, into the list of video_signal_info( )) syntax structures in the VPS, of the video_signal_info( )) syntax structure that applies to the layer with nuh_layer_id equal to layer_id_in_nuh[i]. When i is equal to 0 or vps_num_video_signal_info_minus1 is equal to 0, the value of vps_video_signal_info_idx[i] is inferred to be equal to 0. The value of vps_video_signal_info_idx[i] may be in the range of 0 to vps_num_video_signal_info_minus1, inclusive.
The video_signal_info( ) within the vps_extension( ) illustrated in Table 11 may reference syntax and semantics related to the video signal. For example, the video_signal_info( ) syntax and semantics is illustrated in Table 12.

TABLE 12

Descriptor

video_signal_info( ) {

| | |
|---|---|
| video_vps_format | u(3) |
| video_full_range_vps_flag | u(1) |
| colour_primaries_vps | u(8) |
| transfer_characteristics_vps | u(8) |
| matrix_coeffs_vps | u(8) |

}

The video_vps_format, video_full_range_vps_flag, colour_primaries_vps, transfer_characteristics_vps, matrix_coeffs_vps are used for inference of the values of the SPS VUI syntax elements video_format, video_full_range_flag, colour_primaries, transfer_characteristics, matrix_coeffs respectively, for each SPS that refers to the VPS. For each of these syntax elements, all constraints, if any, that apply to the value of the corresponding SPS syntax element may also apply.

‘video_format_vps’ indicates the representation of the pictures as specified in Table E-2, before being coded in accordance with this Specification. When the video_format_vps syntax element is not present, video_format value is inferred to be equal to 5. The values 6 and 7 for video_format are reserved for future use by ITU-T|ISO/IEC and shall not be present in bitstreams conforming to this version of this Specification. Decoders shall interpret the values 6 and 7 for video_format as equivalent to the value 5.

TABLE 13
Meaning of video_format_vps

| video_format_vps | Meaning |
|---|---|
| 0 | Component |
| 1 | PAL |
| 2 | NTSC |
| 3 | SECAM |
| 4 | MAC |
| 5 | Unspecified video format |

‘video_full_range_vps_flag’ indicates the black level and range of the luma and chroma signals as derived from E′_{Y}, E′_{PB}, and E′_{PR}, or E′_{R}, E′_{G}, and E′_{B} real-valued component signals.

When the video_full_range_vps_flag syntax element is not present, the value of video_full_range_flag is inferred to be equal to 0.

‘colour_primaries_vps’ indicates the chromaticity coordinates of the source primaries as specified in Table 14 in terms of the CIE 1931 definition of x and y as specified in ISO 11664-1.

When the colour_primaries_vps syntax element is not present, the value of colour_primaries is inferred to be equal to 2 (the chromaticity is unspecified or is determined by the application). Values of colour_primaries_vps that are identified as reserved in Table 14 are reserved for future use by ITU-T|ISO/IEC and shall not be present in bitstreams conforming to this version of this Specification. Decoders shall interpret reserved values of colour_primaries as equivalent to the value 2.

TABLE 14
Colour primaries

| Value | Primaries | | | Informative Remark |
|---|---|---|---|---|
| 0 | Reserved | | | For future use by ITU-T \| ISO/IEC |
| 1 | primary | x | y | Rec. ITU-R BT.709-5 |
| | green | 0.300 | 0.600 | Rec. ITU-R BT.1361 conventional colour gamut |
| | blue | 0.150 | 0.060 | system and extended colour gamut system |
| | red | 0.640 | 0.330 | IEC 61966-2-1 (sRGB or sYCC) |
| | white D65 | 0.3127 | 0.3290 | IEC 61966-2-4 |
| | | | | Society of Motion Picture and Television |
| | | | | Engineers RP 177 (1993) Annex B |
| 2 | Unspecified | | | Image characteristics are unknown or are |
| | | | | determined by the application. |
| 3 | Reserved | | | For future use by ITU-T \| ISO/IEC |
| 4 | primary | x | y | Rec. ITU-R BT.470-6 System M (historical) |
| | green | 0.21 | 0.71 | United States National Television System |
| | blue | 0.14 | 0.08 | Committee 1953 Recommendation for |
| | red | 0.67 | 0.33 | transmission standards for colour television |
| | white C | 0.310 | 0.316 | United States Federal Communications |
| | | | | Commission Title 47 Code of Federal Regulations |
| | | | | (2003) 73.682 (a) (20) |
| 5 | primary | x | y | Rec. ITU-R BT.470-6 System B, G (historical) |
| | green | 0.29 | 0.60 | Rec. ITU-R BT.601-6 625 |
| | blue | 0.15 | 0.06 | Rec. ITU-R BT.1358 625 |
| | red | 0.64 | 0.33 | Rec. ITU-R BT.1700 625 PAL and 625 SECAM |
| | white D65 | 0.3127 | 0.3290 | |
| 6 | primary | x | y | Rec. ITU-R BT.601-6 525 |
| | green | 0.310 | 0.595 | Rec. ITU-R BT.1358 525 |
| | blue | 0.155 | 0.070 | Rec. ITU-R BT.1700 NTSC |
| | red | 0.630 | 0.340 | Society of Motion Picture and Television |
| | white D65 | 0.3127 | 0.3290 | Engineers 170M (2004) |
| | | | | (functionally the same as the value 7) |
| 7 | primary | x | y | Society of Motion Picture and Television |
| | green | 0.310 | 0.595 | Engineers 240M (1999) |
| | blue | 0.155 | 0.070 | (functionally the same as the value 6) |
| | red | 0.630 | 0.340 | |
| | white D65 | 0.3127 | 0.3290 | |
| 8 | primary | x | y | Generic film (colour filters using Illuminant C) |
| | green | 0.243 | 0.692 (Wratten 58) | |
| | blue | 0.145 | 0.049 (Wratten 47) | |
| | red | 0.681 | 0.319 (Wratten 25) | |
| | white C | 0.310 | 0.316 | |
| 9 | primary | x | y | Rec. ITU-R BT.2020 |
| | green | 0.170 | 0.797 | |
| | blue | 0.131 | 0.046 | |
| | red | 0.708 | 0.292 | |
| | white D65 | 0.3127 | 0.3290 | |

| | | |
|---|---|---|
| 10 . . . | Reserved | For future use by ITU-T \| ISO/IEC |
| 255 | | |

‘transfer_characteristics_vps’ indicates the opto-electronic transfer characteristic of the source picture as specified in Table 15 as a function of a linear optical intensity input Lc with a nominal real-valued range of 0 to 1.

When the transfer_characteristics_vps syntax element is not present, the value of transfer_characteristics is inferred to be equal to 2 (the transfer_characteristics are unspecified or are determined by the application). Values of transfer_characteristics_vps that are identified as reserved in Table 15 are reserved for future use by ITU-T|ISO/IEC and shall not be present in bitstreams conforming to this version of this Specification. Decoders shall interpret reserved values of transfer_characteristics as equivalent to the value 2.

TABLE 15
Transfer characteristics

| Value | Transfer Characteristic | | Informative Remark |
|---|---|---|---|
| 0 | Reserved | | For future use by ITU-T \| ISO/IEC |
| 1 | V = 1.099 * L_{c}^{0.45} − 0.099 | for 1 >= L_{c} >= 0.018 | Rec. ITU-R BT.709-5 |
| | V = 4.500 * L_{c} | for 0.018 > L_{c} >= 0 | Rec. ITU-R BT.1361 conventional |
| | | | colour gamut system |
| | | | (functionally the same as the value 6) |
| 2 | Unspecified | | Image characteristics are unknown or |
| | | | are determined by the application. |
| 3 | Reserved | | For future use by ITU-T \| ISO/IEC |
| 4 | Assumed display gamma 2.2 | | Rec. ITU-R BT.470-6 System M |
| | | | (historical) |
| | | | United States National Television |
| | | | System Committee 1953 |
| | | | Recommendation for transmission |
| | | | standards for colour television |
| | | | United States Federal Communications |
| | | | Commission Title 47 Code of Federal |
| | | | Regulations (2003) 73.682 (a) (20) |
| | | | Rec. ITU-R BT.1700 (2007 revision) |
| | | | 625 PAL and 625 SECAM |
| 5 | Assumed display gamma 2.8 | | Rec. ITU-R BT.470-6 System B, G |
| | | | (historical) |
| 6 | V = 1.099 * L_{c}^{0.45} − 0.099 | for 1 >= L_{c} >= 0.018 | Rec. ITU-R BT.601-6 525 or 625 |
| | V = 4.500 * L_{c} | for 0.018 > L_{c} >= 0 | Rec. ITU-R BT.1358 525 or 625 |
| | | | Rec. ITU-R BT.1700 NTSC |
| | | | Society of Motion Picture and |
| | | | Television Engineers 170M (2004) |
| | | | (functionally the same as the value 1) |
| 7 | V = 1.1115 * L_{c}^{0.45} − 0.1115 | for 1 >= L_{c} >= 0.0228 | Society of Motion Picture and |
| | V = 4.0 * L_{c} | for 0.0228 > L_{c} >= 0 | Television Engineers 240M (1999) |
| 8 | V = L_{c} | for 1 > L_{c} >= 0 | Linear transfer characteristics |
| 9 | V = 1.0 + Log10(L_{c}) ÷ 2 | for 1 >= L_{c} >= 0.01 | Logarithmic transfer characteristic |
| | V = 0.0 | for 0.01 > L_{c} >= 0 | (100:1 range) |
| 10 | V = 1.0 + Log10(L_{c}) ÷ 2.5 | for 1 >= L_{c} >= | Logarithmic transfer characteristic |
| | V = 0.0 | Sqrt(10) ÷ 1000 | (100 * Sqrt(10): 1 range) |
| | | for Sqrt(10) ÷ 1000 > | |
| | | L_{c} >= 0 | |
| 11 | V = 1.099 * L_{c}^{0.45} − 0.099 | for L_{c} >= 0.018 | IEC 61966-2-4 |
| | V = 4.500 * L_{c} | for 0.018 > L_{c} > −0.018 | |
| | V = −1.099 * (−L_{c})^{0.45} + | for −0.018 >= L_{c} | |
| | 0.099 | | |
| 12 | V = 1.099 * L_{c}^{0.45} − 0.099 | for 1.33 > L_{c} >= 0.018 | Rec. ITU-RBT.1361 extended colour |
| | V = 4.500 * L_{c} | for 0.018 > L_{c} > = −0.0045 | gamut system |
| | V = −(1.099 * (−4 * | for −0.0045 > L_{c} >= −0.25 | |
| | L_{c})^{0.45} − 0.099) ÷ 4 | | |
| 13 | V = 1.055 * L_{c}^{(1 ÷ 2.4)} − 0.055 | for 1 >= L_{c} >= 0.0031308 | IEC 61966-2-1 (sRGB or sYCC) |
| | V = 12.92 * L_{c} | for 0.0031308 > L_{c} >= 0 | |
| 14 | V = 1.099 * L_{c}^{0.45} − 0.099 | for 1 >= L_{c} >= 0.018 | Rec. ITU-R BT.2020 for 10 bit system |
| | V = 4.500 * L_{c} | for 0.018 > L_{c} >= 0 | |
| 15 | V = 1.0993 * L_{c}^{0.45} − 0.0993 | for 1 >= L_{c} >= 0.0181 | Rec. ITU-R BT.2020 for 12 bit system |
| | V = 4.500 * L_{c} | for 0.0181 > L_{c} >= 0 | |

| | | |
|---|---|---|
| 15 . . . | Reserved | For future use by ITU-T \| ISO/IEC |
| 255 | | |

‘matrix_coeffs_vps’ describes the matrix coefficients used in deriving luma and chroma signals from the green, blue, and red primaries, as specified in Table 16.

The matrix_coeffs_vps shall not be equal to 0 unless one or more of the following conditions are true:
BitDepth_{C} is equal to BitDepth_{Y},
chroma_format_idc is equal to 3 (4:4:4).

The specification of the use of matrix_coeffs equal to 0 under all other conditions is reserved for future use by ITU-T|ISO/IEC.

The matrix_coeffs shall not be equal to 8 unless one of the following conditions is true:
BitDepth_{C} is equal to BitDepth_{Y},
BitDepth_{C} is equal to BitDepth_{Y}+1 and chroma_format_idc is equal to 3 (4:4:4).

The specification of the use of matrix_coeffs equal to 8 under all other conditions is reserved for future use by ITU-T|ISO/IEC.

When the matrix_coeffs syntax element is not present, the value of matrix_coeffs is inferred to be equal to 2 (unspecified).

The interpretation of matrix_coeffs, together with colour_primaries and transfer_characteristics, is specified by the equations below.

E_{R}, E_{G}, and E_{B} are defined as “linear-domain” real-valued signals based on the indicated colour primaries before application of the transfer characteristics function. The application of the transfer characteristics function is denoted by (x)′ for an argument x. The signals E′_{R}, E′_{G}, and E′_{B} are determined by application of the transfer characteristics function as follows:

E′_{R}=(E_{R})′ (E-1)

E′_{G}=(E_{G})′ (E-2)

E′_{B}⁼(E_{B})′ (E-3)

The range of E′_{R}, E′_{G}, and E′_{B} is specified as follows:

If transfer_characteristics is not equal to 11 or 12, E′_{R}, E′_{G}, and E′_{B} are real numbers with values in the range of 0 to 1 inclusive.

Otherwise, (transfer_characteristics is equal to 11 (IEC 61966-2-4) or 12 (Rec. ITU-R BT.1361 extended colour gamut system)), E′_{R}, E′_{G} and E′_{B} are real numbers with a larger range not specified in this Specification.

Nominal white is specified as having E′_{R} equal to 1, E′_{G} equal to 1, and E′_{B} equal to 1.

Nominal black is specified as having E′_{R} equal to 0, E′_{G} equal to 0, and E′_{B} equal to 0.

The interpretation of matrix_coeffs is specified as follows:
If video_full_range_flag is equal to 0, the following applies:
   If matrix_coeffs is equal to 1, 4, 5, 6, 7, 9, or 10, the following equations apply:

Y=Clip1_{Y}(Round((1<<(BitDepth_{Y}−8))*(219*E′_{Y}+16))) (E-4)

Cb=Clip1_{C}(Round((1<<(BitDepth_{C}−8))*(224*E′_{PB}+128))) (E-5)

Cr=Clip1_{C}(Round((1<<(BitDepth_{C}−8))*(224*E′_{PR}+128))) (E-6)
Otherwise, if matrix_coeffs is equal to 0 or 8, the following equations apply:

R=Clip1_{Y}((1<<(BitDepth_{Y}−8))*(219*E′_{R}+16)) (E-7)

G=Clip1_{Y}((1<<(BitDepth_{Y}−8))*(219*E′_{G}+16)) (E-8)

B=Clip1_{Y}((1<<(BitDepth_{Y}−8))*(219*E′_{B}+16)) (E-9)
Otherwise, if matrix_coeffs is equal to 2, the interpretation of the matrix_coeffs syntax element is unknown or is determined by the application.
Otherwise (matrix_coeffs is not equal to 0, 1, 2, 4, 5, 6, 7, 8, 9, or 10), the interpretation of the matrix_coeffs syntax element is reserved for future definition by ITU-T|ISO/IEC.
Otherwise (video_full_range_flag is equal to 1), the following applies:
   If matrix_coeffs is equal to 1, 4, 5, 6, 7, 9 or 10 the following equations apply:

Y=Clip1_{Y}(Round(((1<<BitDepth_{Y})−1)*E′_{Y})) (E-10)

Cb=Clip1_{C}(Round(((1<<BitDepth_{C})−1)*E′_{PB}+(1<<BitDepth_{C}−1)))) (E-11)

Cr=Clip1_{C}(Round(((1<<BitDepth_{C})−1)*E′_{PR}+(1<<(BitDepth_{C}−1)))) (E-12)
Otherwise, if matrix_coeffs is equal to 0 or 8, the following equations apply:

R=Clip1_{Y}(((1<<BitDepth_{Y})−1)*E′_{R})

G=Clip1_{Y}(((1<<BitDepth_{Y})−1)*E′_{R})

B=Clip1_{Y}(((1<<BitDepth_{Y})−1)*E′_{B})
Otherwise, if matrix_coeffs is equal to 2, the interpretation of the matrix_coeffs syntax element is unknown or is determined by the application.
Otherwise (matrix_coeffs is not equal to 0, 1, 2, 4, 5, 6, 7, 8, 9 or 10), the interpretation of the matrix_coeffs syntax element is reserved for future definition by ITU-T|ISO/IEC. Reserved values for matrix_coeffs shall not be present in bitstreams conforming to this version of this Specification. Decoders shall interpret reserved values of matrix_coeffs as equivalent to the value 2.

The variables E′_{Y}, E′_{PB}, and E′_{PR} (for matrix_coeffs not equal to 0 or 8) or Y, Cb, and Cr (for matrix_coeffs equal to 0 or 8) are specified as follows:
If matrix_coeffs is not equal to 0, 8, or 10, the following equations apply:

E′_{Y}=K_{R}*E′_{R}+(1−K_{R}−K_{B})*+K_{B}*E′_{G}+K_{B}*E′_{B}

E′_{PB}=0.5*(E′_{B}−E′_{Y})÷(1−K_{B}) (E-17)

E′_{PR}=0.5*(E′_{R}−E′_{Y})÷(1−K_{R}) (E-18)
E′_{Y} is a real number with the value 0 associated with nominal black and the value 1 associated with nominal white. E′_{RB} and E′_{PR} are real numbers with the value 0 associated with both nominal black and nominal white. When transfer_characteristics is not equal to 11 or 12, E′_{Y} is a real number with values in the range of 0 to 1 inclusive. When transfer_characteristics is not equal to 11 or 12, E′_{PB} and E′_{PR} are real numbers with values in the range of 0.5 to 0.5 inclusive. When transfer_characteristics is equal to 11 (IEC 61966-2-4), or 12 (ITU-R BT.1361 extended colour gamut system), E′_{Y}, E′_{PB} and E′_{PR} are real numbers with a larger range not specified in this Specification.
Otherwise, if matrix_coeffs is equal to 0, the following equations apply:

Y=Round(G) (E-19)

Cb=Round(B) (E-20)

Cr=Round(R) (E-21)
Otherwise, if matrix_coeffs is equal to 8, the following applies:
   If BitDepth_{C} is equal to BitDepth_{Y}, the following equations apply:

Y=Round(0.5*G+0.25*(R+B)) (E-22)

Cb=Round(0.5*G−0.25*(R+B))+(1<<(BitDepth_{C}−1)) (E-23)

Cr=Round(0.5*(R−B))+(1<<(BitDepth_{C}−1)) (E-24)
For purposes of the YCgCo nomenclature used in Table E-5, Cb and Cr of Equations E-23 and E-24 may be referred to as Cg and Co, respectively. The inverse conversion for the above three equations should be computed as:

t=Y−(Cb−(1<<(BitDepth_{C}−1))) (E-25)

G=Clip1_{Y}(Y+(Cb−(1<<(BitDepth_{C}−1)))) (E-26)

B=Clip1_{Y}(t−(Cr−(1<<(BitDepth_{C}−1)))) (E-27)

R=Clip1_{Y}(t+(Cr−(1<<(BitDepth_{C}−1)))) (E-28)
Otherwise (BitDepth_{C} is not equal to BitDepth_{Y}), the following equations apply:

Cr=Round(R)−Round(B)+(1<<(BitDepth_{C}−1)) (E-29)

t=Round(B)+((Cr−(1<<(BitDepth_{C}−1)))>>1) (E-30)

Cb=Round(G)−t+(1<<(BitDepth_{C}−1)) (E-31)

Y=t+((Cb−(1<<(BitDepth_{C}−1)))>>1) (E-32)
For purposes of the YCgCo nomenclature used in Table E-5, Cb and Cr of Equations E-31 and E-29 may be referred to as Cg and Co, respectively. The inverse conversion for the above four equations should be computed as.

t=Y−((Cb−(1<<(BitDepth_{C}−1)))>>1) (E-33)

G=Clip1_{Y}(t+(Cb−(1<<(BitDepth_{C}1)))) (E-34)

B=Clip1_{Y}(t−((Cr−(1<<(BitDepth_{C}−1)))>>1)) (E-35)

R=Clip1_{Y}(B+(Cr−(1<<(BitDepth_{C}−1)))) (E-36)
Otherwise (matrix_coeffs is equal to 10), the following equations apply:

E_{Y}=K_{R}*E_{R}+(1−K_{R}−K_{B})*E_{G}+K_{B}*E_{B}

E′_{Y}=(E_{Y})′ (E-37)
In this case, E_{Y} is defined from the “linear-domain” signals for E_{R}, E_{G}, and E_{B}, prior to application of the transfer characteristics function, which is then applied to produce the signal E′_{Y}. E_{Y} and E′_{Y} are analogue with the value 0 associated with nominal black and the value 1 associated with nominal white.

E′_{PB}=(E′_{B}−E′_{Y})÷1.9404 for −0.9702<=E′_{B}−E′_{Y}<=0 (E-39)

E′_{PB}=(E′_{B}−E′_{Y})÷1.5816 for 0<E′_{B}−E′_{Y}<=0.7908 (E-40)

E′_{PR}=(E′_{Y})÷1.7184 for 0.8592<=E′_{R}−E′_{Y}<=0 (E-41)

E′_{PR}=(E′_{R}−E′_{Y})÷0.9936 for 0<E′_{R}−E′_{Y}<=0.4968 (E-42)

TABLE 16
Matrix coefficients

| Value | Matrix | Informative remark |
|---|---|---|
| 0 | GBR | Typically referred to as RGB; see Equations |
| | | E-19 to E-21 IEC 61966-2-1 (sRGB) |
| 1 | K_{R} = 0.2126; | ITU-R Rec. BT.709-5 |
| | K_{B} = 0.0722 | ITU-R Rec. BT.1361 conventional colour |
| | | gamut system and extended colour |
| | | gamut system |
| | | IEC 61966-2-1 (sYCC) |
| | | IEC 61966-2-4 xvYCC₇₀₉ |
| | | Society of Motion Picture and Television |
| | | Engineers RP 177 (1993) Annex B |
| 2 | Unspecified | Image characteristics are unknown or are |
| | | determined by the application. |
| 3 | Reserved | For future use by ITU-T \| ISO/IEC |
| 4 | K_{R} = 0.30; | United States Federal Communications |
| | K_{B} = 0.11 | Commission Title 47 Code of Federal |
| | | Regulations (2003) 73.682 (a) (20) |
| 5 | K_{R} = 0.299; | ITU-R Rec. BT.470-6 System B, G (historical) |
| | K_{B} = 0.114 | ITU-R Rec. BT.601-6 625 |
| | | ITU-R Rec. BT.1358 625 |
| | | ITU-R Rec. BT.1700 625 PAL and |
| | | 625 SECAM |
| | | IEC 61966-2-4 xvYCC₆₀₁ |
| | | (functionally the same as the value 6) |
| 6 | K_{R} = 0.299; | ITU-R Rec. BT.601-6 525 |
| | K_{B} = 0.114 | ITU-R Rec. BT.1358 525 |
| | | ITU-R Rec. BT.1700 NTSC |
| | | Society of Motion Picture and Television |
| | | Engineers 170M (2004) |
| | | (functionally the same as the value 5) |
| 7 | K_{R} = 0.212; | Society of Motion Picture and Television |
| | K_{B} = 0.087 | Engineers 240M (1999) |
| 8 | YCgCo | See Equations E-22 to E-36 |
| 9 | K_{R} = 0.2627; | Rec. ITU-R BT.2020 non-constant luminance |
| | K_{B} = 0.0593 | system |
| | | See Equations E-16 to E-18 |
| 10 | K_{R} = 0.2627; | Rec. ITU-R BT.2020 constant luminance |
| | K_{B} = 0.0593 | system |
| | | See Equations E-37 to E-42 |
| 11 . . . | Reserved | For future use by ITU-T \| ISO/IEC |
| 255 | | |

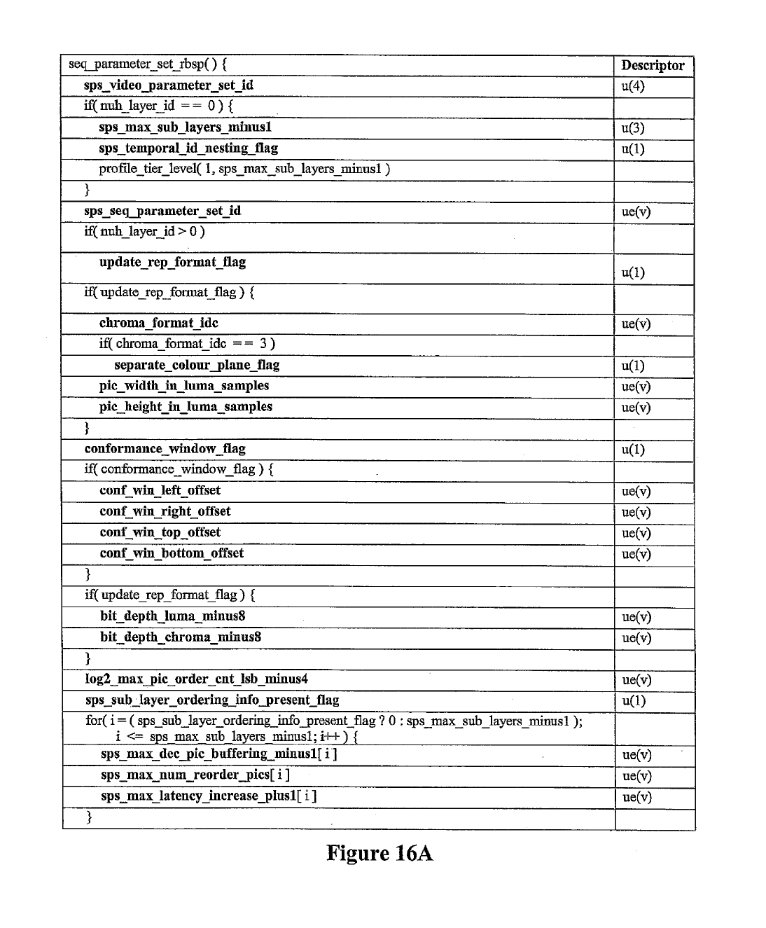

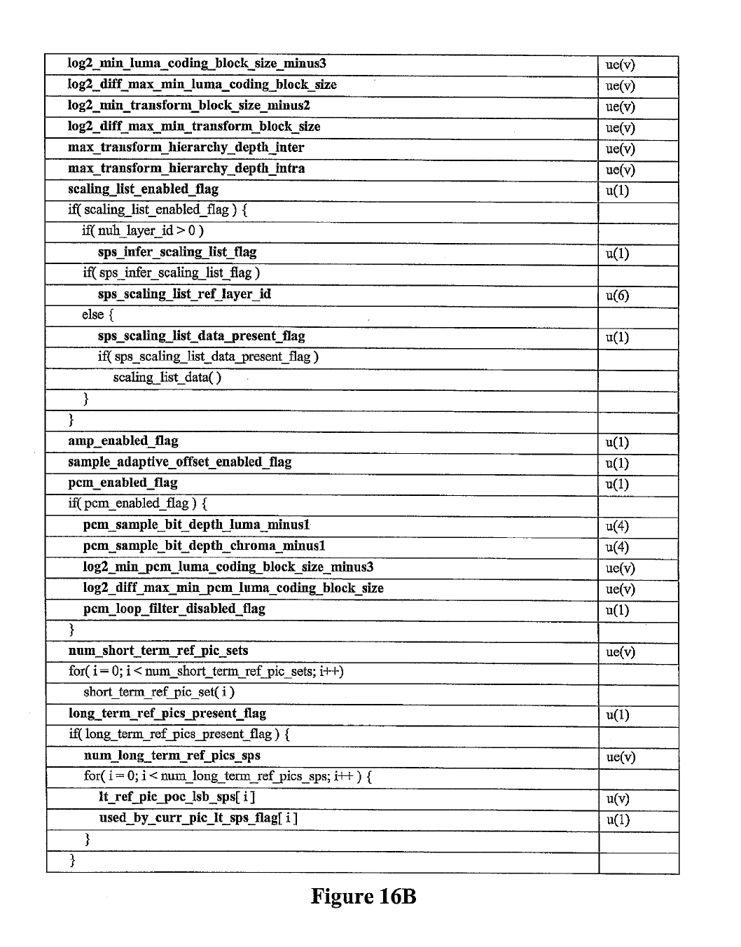

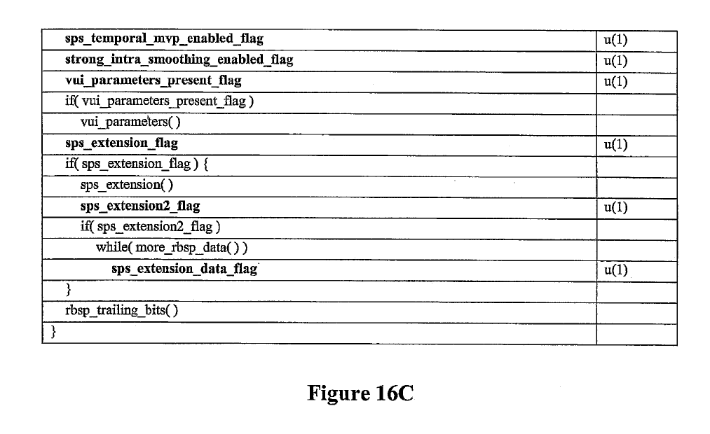

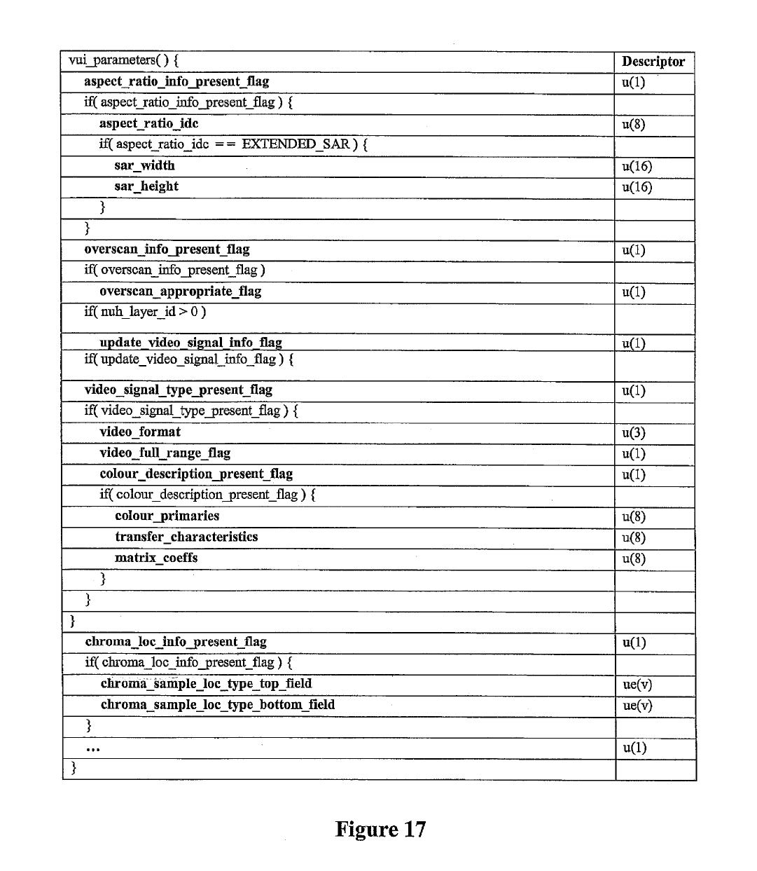

Referring to FIG. 16A-16C, an exemplary seq_parameter_set_rbsp( ) syntax and semantics illustrated. In particular the SPS syntax and semantics of FIG. 16A-16C includes the vui_parameters( ) Referring to FIG. 17, an exemplary vui_parameters( ) is illustrated that includes a flag indicating where to locate selected video information depending on whether it is a base layer or an enhancement layer (nuh_layer_id>0).

The update video_signal_info_flag equal to 1 specifies that the syntax elements video_format, video_full_range_flag, colour_primaries, transfer_characteristics, and matrix_coeffs are explicitly signalled in the SPS and all the layers with nuh_layer_id greater than zero that refer to this SPS use these values instead of those signalled in the VPS when the nuh_layer_id of the SPS is greater than 0.

The update video_signal_info_flag equal to 0 specifies that the syntax elements video_format, video_full_range_flag, colour_primaries, transfer_characteristics, and matrix_coeffs respectively, are not signalled in the SPS and all the layers that refer to this SPS use the values signaled in the VPS. When not present, the value of update video_signal_info_flag is inferred to be equal to 1.

When a current picture with nuh_layer_id layerIdCurr greater than 0 refers to an SPS, the values of video_format, video_full_range_flag, colour_primaries, transfer_characteristics, and matrix_coeffs may be inferred or constrained as follows:

If the nuh_layer_id of the active layer SPS is equal to 0, the values of video_format, video_full_range_flag, colour_primaries, transfer_characteristics, and matrix_coeffs are inferred to be equal to video_vps_format, video_full_range_vps_flag, colour_primaries_vps, transfer_characteristics_vps, and matrix_coeffs_vps, respectively, of the vps_video_signal_info_idx[j]-th video_signal_info( )) syntax structure in the active VPS where j is equal to LayerIdxInVps[layerIdCurr] and the values of video_format, video_full_range_flag, colour_primaries, transfer_characteristics, and matrix_coeffs of the active layer SPS are ignored. The values are inferred from the VPS when an active non-base layer references an SPS which is also used by the base layer, in which case the SPS has nuh_layer_id equal to 0. For an active base layer, the values in the active SPS apply.

Otherwise (the nuh_layer_id of the active layer SPS is greater than zero), the following may be applied. If update video_signal_info_flag is equal to 0, the values of video_format, video_full_range_flag, colour_primaries, transfer_characteristics, and matrix_coeffs are inferred to be equal to video_vps_format, video_full_range_vps_flag, colour_primaries_vps, transfer_characteristics_vps, and matrix_coeffs_vps, respectively, of the vps_video_signal_info_idx[j]-th video_signal_info( )) syntax structure in the active VPS, where j is equal to LayerIdxInVps[layerIdCurr]. Otherwise (update video_signal_info_flag is equal to 1 and the nuh_layer_id of the active layer SPS is greater than zero), it is a requirement of bitstream conformance that the value of video_format, video_full_range_flag, colour_primaries, transfer_characteristics, and matrix_coeffs shall be lower than or equal to in terms of capability than video_format, video_full_range_flag, colour_primaries, transfer_characteristics, and matrix_coeffs, respectively, of the vps_video_signal_info_idx[j]-th video_signal_info( )) syntax structure in the active VPS, where j is equal to LayerIdxInVps[layerIdCurr]. In another embodiment otherwise (update video_signal_info_flag is equal to 1 and the nuh_layer_id of the active layer SPS is greater than zero), it is a requirement of bitstream conformance that the value of at least one of video_format, video_full_range_flag, colour_primaries, transfer_characteristics, and matrix_coeffs shall be different than the values of video_vps_format, video_full_range_vps_flag, colour_primaries_vps, transfer_characteristics_vps, and matrix_coeffs_vps, respectively, of the vps_video_signal_info_idx[j]-th video_signal_info( )) syntax structure in the active VPS, where j is equal to LayerIdxInVps[layerIdCurr].

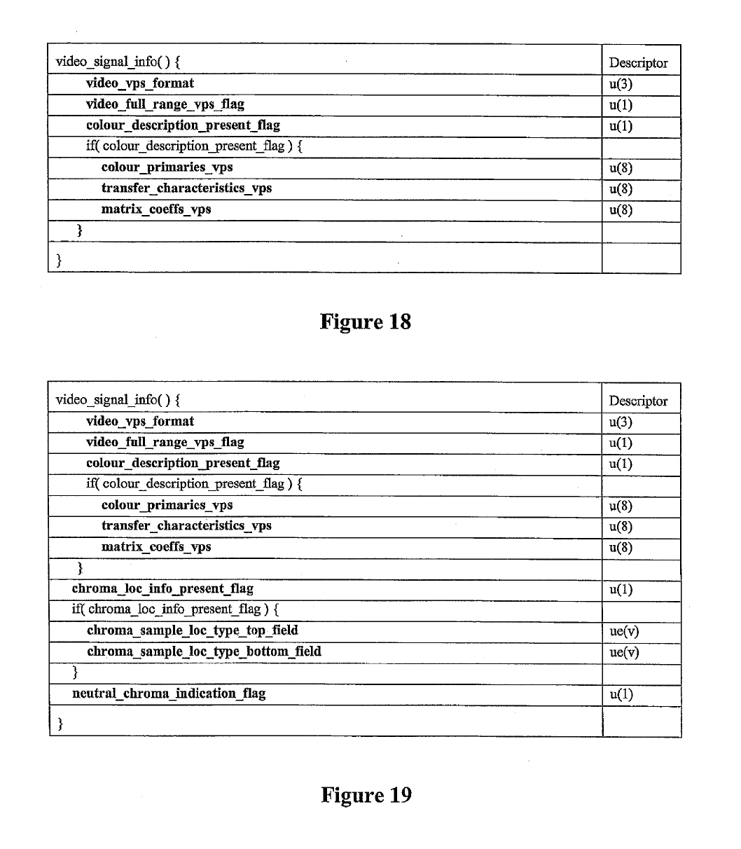

Referring to FIG. 18, in another embodiment a flag colour_description_present_flag is further included in video_signal_info( ) and signaled in VPS and some of the syntax elements in video_signal_info( ) are conditioned based on its value.

Referring to FIG. 19, in another embodiment information regarding chroma (chroma_loc_info_present_flag, chroma_sample_loc_type_top_field, chroma_sample_loc_type_bottom_field) is further included in video_signal_info( ) and signalled in VPS. In this case these syntax elements may not be signalled in SPS when using VPS for SPS sharing.

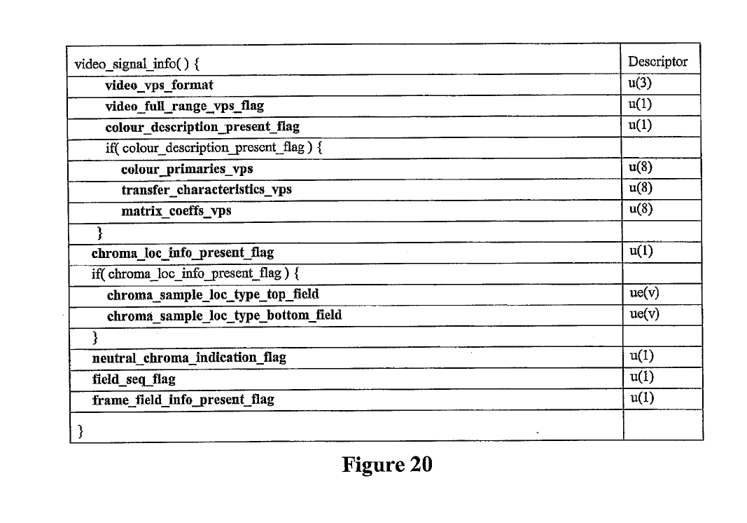

Referring to FIG. 20, in another embodiment information regarding frame/field (field_seq_flag, frame_field_info_present_flag) is further included in video_signal_info( ) and signalled in VPS. In this case these syntax elements may not be signalled in SPS when using VPS for SPS sharing.

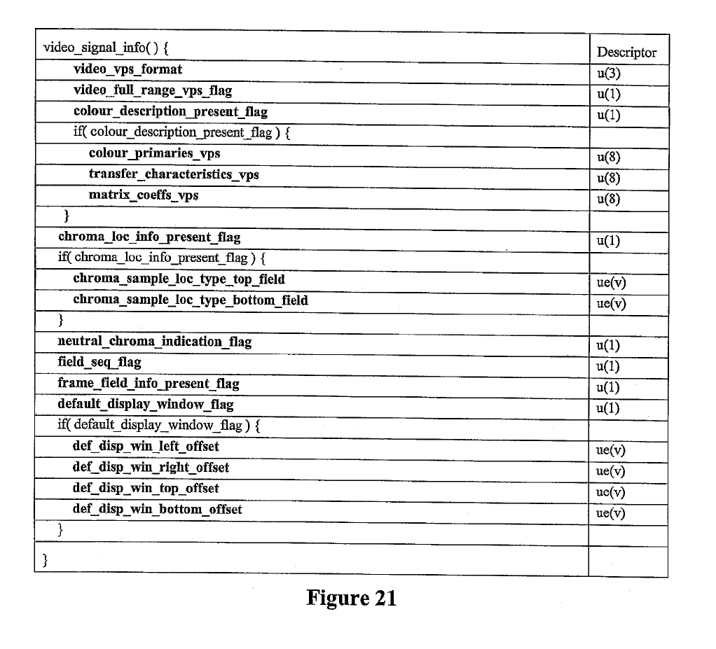

Referring to FIG. 21, in another embodiment information regarding default window (default_display_window_flag, def_disp_win_left_offset, def_disp_win_right_offset, def_disp_win_top_offset, def_disp_win_bottom_offset) is further included in video_signal_info( ) and signalled in VPS. In this case these syntax elements may not be signalled in SPS when using VPS for SPS sharing.

In yet another variant the video_signal_info( ) may be signaled in VPS as proposed but the SPS may be signaled unchanged, thus not using VPS to SPS sharing for the elements signaled in video_signal_info( ).

In another embodiments one or more of syntax elements may be signaled with a different syntax element name.

In another embodiment one or more of the syntax elements may be signaled using a known fixed number of bits instead of u(v) instead of ue(v). For example they could be signaled using u(8) or u(16) or u(32) or u(64), etc.

In another embodiment one or more of these syntax element could be signaled with ue(v) or some other coding scheme instead of fixed number of bits such as u(v) coding.

In another embodiment the names of various syntax elements and their semantics may be altered by adding a plus1 or plus2 or by subtracting a minus1 or a minus2 compared to the described syntax and semantics.

In yet another embodiment various syntax elements may be signaled per picture anywhere in the bitstream. For example they may be signaled in slice segment header, pps/ sps/ vps/ or any other parameter set or other normative part of the bitstream.

The system and apparatus described above may use dedicated processor systems, micro controllers, programmable logic devices, microprocessors, or any combination thereof, to perform some or all of the operations described herein. Some of the operations described above may be implemented in software and other operations may be implemented in hardware. Any of the operations, processes, and/or methods described herein may be performed by an apparatus, a device, and/or a system substantially similar to those as described herein and with reference to the illustrated figures.

The processing device may execute instructions or “code” stored in memory. The memory may store data as well. The processing device may include, but may not be limited to, an analog processor, a digital processor, a microprocessor, a multi-core processor, a processor array, a network processor, or the like. The processing device may be part of an integrated control system or system manager, or may be provided as a portable electronic device configured to interface with a networked system either locally or remotely via wireless transmission.

The processor memory may be integrated together with the processing device, for example RAM or FLASH memory disposed within an integrated circuit microprocessor or the like. In other examples, the memory may comprise an independent device, such as an external disk drive, a storage array, a portable FLASH key fob, or the like. The memory and processing device may be operatively coupled together, or in communication with each other, for example by an I/O port, a network connection, or the like, and the processing device may read a file stored on the memory. Associated memory may be “read only” by design (ROM) by virtue of permission settings, or not. Other examples of memory may include, but may not be limited to, WORM, EPROM, EEPROM, FLASH, or the like, which may be implemented in solid state semiconductor devices. Other memories may comprise moving parts, such as a known rotating disk drive. All such memories may be “machine-readable” and may be readable by a processing device.

Operating instructions or commands may be implemented or embodied in tangible forms of stored computer software (also known as “computer program” or “code”). Programs, or code, may be stored in a digital memory and may be read by the processing device. “Computer-readable storage medium” (or alternatively, “machine-readable storage medium”) may include all of the foregoing types of memory, as well as new technologies of the future, as long as the memory may be capable of storing digital information in the nature of a computer program or other data, at least temporarily, and as long at the stored information may be “read” by an appropriate processing device. The term “computer-readable” may not be limited to the historical usage of “computer” to imply a complete mainframe, mini-computer, desktop or even laptop computer. Rather, “computer-readable” may comprise storage medium that may be readable by a processor, a processing device, or any computing system. Such media may be any available media that may be locally and/or remotely accessible by a computer or a processor, and may include volatile and non-volatile media, and removable and non-removable media, or any combination thereof.

A program stored in a computer-readable storage medium may comprise a computer program product. For example, a storage medium may be used as a convenient means to store or transport a computer program. For the sake of convenience, the operations may be described as various interconnected or coupled functional blocks or diagrams. However, there may be cases where these functional blocks or diagrams may be equivalently aggregated into a single logic device, program or operation with unclear boundaries.

One of skill in the art will recognize that the concepts taught herein can be tailored to a particular application in many other ways. In particular, those skilled in the art will recognize that the illustrated examples are but one of many alternative implementations that will become apparent upon reading this disclosure.

Although the specification may refer to “an”, “one”, “another”, or “some” example(s) in several locations, this does not necessarily mean that each such reference is to the same example(s), or that the feature only applies to a single example.

It is to be understood that the claims are not limited to the precise configuration and components illustrated above. Various modifications, changes and variations may be made in the arrangement, operation and details of the systems, methods, and apparatus described herein without departing from the scope of the claims.

1: A method for decoding video comprising:
(a) receiving a video bitstream of encoded pictures, wherein said video bitstream includes a plurality of layers; and
(b) receiving video parameter set (VPS) video usability information (VUI) related to said video bitstream, wherein said VPS VUI information includes
(1) a set of a video signal information;
(2) the number of said set of said video signal information;
(3) an index of said set of said video signal information; and
(4) a flag which indicates whether or not said number and said index are present.

2: The method of claim 1 wherein said flag equal to 1 indicates that said number and said index are present, and said flag equal to 0 indicates that said number and said index are not present.

3: The method of claim 1 wherein said set references syntax and semantics related to said video bitstream.

4: The method of claim 1 wherein said video signal information is one of (1) a video_vps_format element; (2) a video_full_range_vps_flag element; (3) a colour_primaries_vps element; (4) a transfer_characteristics_vps element; and (5) a matrix_coeffs_vps element.

5: The method of claim 4 wherein said video_vps_format element, said video_full_range_vps_flag element, said colour_primaries_vps element, said transfer_characteristics_vps element, and said matrix_coeffs_vps element are used for inference of the values of a SPS VUI syntax elements video_format, video_full_range_flag, colour_primaries, transfer_characteristics, matrix_coeffs respectively, for each SPS that refers to a video parameter set extension syntax.

6: The method of claim 1 wherein said index is into a list of said video signal information in a video parameter set extension that applies to one of said plurality of layers.
